(19) United States
(12) Patent Application Publication
(10) Pub. No.: US 2013/0184030 A1
(43) Pub. Date: Jul. 18, 2013

(54) METHODS AND APPARATUS FOR GENERATING AND/OR USING A SIGNAL SUPPRESSION UTILITY METRIC

(71) Applicants: Saurabh Tavildar, Jersey City, NJ (US); Zhibin Wu, Bedminster, NJ (US); Junyi Li, Chester, NJ (US); Simone Merlin, San Diego, CA (US); Santosh Paul Abraham, San Diego, CA (US); Nilesh N. Khude, Bridgewater, NJ (US); Hemanth Sampath, San Diego, CA (US)

(72) Inventors: Saurabh Tavildar, Jersey City, NJ (US); Zhibin Wu, Bedminster, NJ (US); Junyi Li, Chester, NJ (US); Simone Merlin, San Diego, CA (US); Santosh Paul Abraham, San Diego, CA (US); Nilesh N. Khude, Bridgewater, NJ (US); Hemanth Sampath, San Diego, CA (US)

(73) Assignee: QUALCOMM Incorporated, San Diego, CA (US)

(21) Appl. No.: 13/349,262

(22) Filed: Jan. 12, 2012

(51) Int. Cl. H04W 88/06

(52) U.S. Cl. 455/552.1

(57) ABSTRACT

Methods and apparatus are described for efficiently suppressing transmission of signals from devices which are using a first protocol, in order to allow the frequency spectrum being used by devices using the first protocol to be used briefly for communication between devices using an alternative communications protocol. In some embodiments, the first protocol is WiFi and the alternative signaling protocol is a non-WiFi peer to peer communications protocol. A wireless communications device, e.g., a peer to peer wireless communications device, generates a signal suppression utility metric (SSUM). The signal suppression utility metric provides an indication of how useful transmitting a transmission suppression signal, e.g., a S-CTS signal which may be a CTS to self signal, will be at a given point in time. The wireless communications device decides whether or not to transmit a transmission suppression signal as a function of the signal suppression utility metric.

### FIELD

Various embodiments are directed to wireless communications where networks share a frequency spectrum, and more specifically, to methods and apparatus for efficiently suppressing signaling in a first network by signaling from devices in a second network.

### BACKGROUND

In some environments, e.g., in regions where there is unlicensed spectrum, it may be desirable for multiple technologies corresponding to different networks to coexist and use the same spectrum. It may be desirable for devices in a second network to temporarily suppress signaling in a first network. One simple approach is for each second network device to transmit a suppression signal used to suppress signal transmission by devices in the first network irrespective of network or other conditions.

The distribution of devices of the second network in a region overlapping with the region of devices of the first network may be expected to vary over time and location. At different times, different numbers of devices from the second network may be clustered in a particular local region. In a situation where multiple devices of the second network are very closely located, the transmission of suppression signals from each of the closely located devices may be redundant and unnecessary resulting in wasted battery power that could otherwise be used for second network communications, e.g., peer to peer traffic signaling. In addition, redundant signaling may not only be wasteful, but in some embodiments, may actually be detrimental to suppression of first network signaling. For example, the collision of signal suppression signals transmitted concurrently from multiple second network devices may result in devices in the first network being unable to recover and respond to the signal suppression signals.

Based on the above discussion there is a need for new methods and apparatus which support efficient signal suppression. It would be beneficial if at least some of the methods and apparatus are responsive changes in conditions in deciding whether or not to transmit a signal suppression signal.

### SUMMARY

Methods and apparatus are described for suppressing signals. Apparatus may, and sometimes do, transmit a signal transmission suppression signal. The apparatus which transmit the suppression signal may, and in some but not all embodiments, do use a second communications protocol which is different from a first communications protocol. The suppression signal suppresses transmission of signals by devices using the first protocol and allows the frequency spectrum being used by devices using the first protocol to be used, e.g., briefly, for communication between devices using an alternative communications protocol. In some embodiments, the first protocol is WiFi protocol and the alternative signaling protocol is a non-WiFi peer to peer communications protocol. In some embodiments, a peer to peer wireless communications device generates and transmits a transmission suppression signal, e.g., a S-CTS (Special Clear To Send) signal, which is detected and treated as a CTS signal by WiFi devices. The WiFi devices refrain from transmitting signals in response to a received S-CTS or CTS signal, thus freeing the spectrum temporarily for peer to peer communications. One example of the S-CTS signal is CTS to Self signal.

Various features are directed to efficiently suppressing signaling in a network. The network maybe a network in which peer to peer signaling, e.g., direct device to device communication, is used. A wireless communications device, e.g., a peer to peer wireless communications device, generates a signal suppression utility metric (SSUM). The signal suppression utility metric provides an indication of how useful transmitting a transmission suppression signal, e.g., a S-CTS signal, will be at a given point in time. In some embodiments, the signal suppression utility metric (SSUM) takes into consideration one or more of the following: the effective coverage area of a transmitted transmission suppression signal, the probability that the transmission suppression signal will result in suppression of signals which would not be suppressed in absence of transmission of the transmission suppression signal and/or the probability that the transmission suppression signal if transmitted will collide with another transmission suppression signal and be ineffective.

Various features are directed to generation of a useful signal suppression utility metric (SSUM) while other features are directed to using a generated SSUM to determine whether or not to transmit a transmission suppression signal, e.g., a S-CTS signal, at a particular point in time. In some embodiments, the SSUM is generated based on one or more of the following: i) the strength of one or more transmission suppression signals received from other devices; ii) how many transmission suppression signals from other devices are received in a period of time; and iii) a combination of how many transmission suppression signals are received in a period of time along with the strength of one or more such received signals. As should be appreciated receipt of one or more strong transmission suppression signals by a wireless communications device indicates that the coverage area to be covered by a transmission suppression signal, if transmitted from the wireless communications device, will be similar to the coverage area already covered by a transmission suppression signal being transmitted by one of the other devices. Receiving a large number of transmission suppression signals indicates that the benefit of an additional transmission suppression signal transmission is likely to be small and/or be counterproductive by resulting in transmission suppression signal collisions.

By making a decision whether or not to transmit a transmission suppression signal, e.g., a S-CTS signal, based on a SSUM value, redundant transmission suppression signaling can be reduced and/or eliminated resulting in the beneficial effects of wireless device power savings, e.g., less battery drain. In addition, by making a decision whether or not to transmit a transmission suppression signal, e.g., a S-CTS signal, based on a SSUM value, the number of collisions of transmission suppression signals can be reduced increasing the likelihood that a transmitted transmission suppression signal will be effective.

An exemplary method of operating a wireless communications device, in accordance with some embodiments, comprises: generating a signal suppression utility metric (SSUM) estimating an effectiveness of transmission of a signal used to suppress transmissions by other devices; and making a decision whether or not to transmit a transmission suppression signal, e.g., a S-CTS signal, based on the value of the generated SSUM. An exemplary wireless communications device, in accordance with some embodiments, comprises at least one processor configured to: generate a signal suppression utility metric (SSUM) estimating an effectiveness of transmission of a signal used to suppress transmissions by other devices; and make a decision whether or not to transmit a transmission suppression signal, e.g., a S-CTS signal, based on the value of the generated SSUM. The exemplary wireless communications further comprises memory coupled to said at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary communications system in accordance with an exemplary embodiment.

FIG. 2A is a first part of a flowchart of an exemplary method of operating a wireless communications device in accordance with various exemplary embodiments.

FIG. 2B is a second part of a flowchart of an exemplary method of operating a wireless communications device in accordance with various exemplary embodiments.

FIG. 3 is a drawing of an exemplary wireless communications device, e.g., a peer to peer wireless communications device, in accordance with an exemplary embodiment.

FIG. 4 is an assembly of modules which can, and in some embodiments is, used in the exemplary wireless communications device illustrated in FIG. 3.

FIG. 5 illustrates three exemplary wireless communications devices, with partially overlapping signal suppression regions, which may, and sometimes do, transmit S-CTS signals to silence WiFi devices in their vicinity.

FIG. 6 illustrates a situation in which the signal suppression signals from second and third wireless communications devices already cover the majority of the signal suppression area that would be reached by a signal suppression signal from a first wireless communications device, and in which case the first wireless communications device may decide not to transmit a signal suppression signal.

FIG. 7 illustrates an example in which a peer to peer wireless communications device generates a low value for a signal suppression utility metric based on a high power received transmission suppression signal from another peer to peer wireless communications device in its vicinity and decides not to transmit a transmit suppression signal.

FIG. 8 illustrates an example in which a peer to peer wireless communications device generates a low value for a signal suppression utility metric based on a high number of received transmission suppression signal from other peer to peer wireless communications device in its vicinity and decides not to transmit a transmit suppression signal.

FIG. 9 illustrates an example in which a peer to peer wireless communications device generates a high value for a signal suppression utility metric based on a low number of received transmission suppression signals from other peer to peer wireless communications device in its vicinity and decides not to transmit a transmit suppression signal.

FIG. 10 illustrates a peer to peer device transmitting a transmission suppression signal in response to the decision to transmit of FIG. 9.

FIG. 11 illustrates an example in which a peer to peer wireless communications device generates a high value for a signal suppression utility metric based on the number of received transmission suppression signals from other peer to peer wireless communications device in its vicinity and the power levels of the received transmission suppression signals and decides not to transmit a transmit suppression signal.

FIG. 12 illustrates a peer to peer device transmitting a transmission suppression signal in response to the decision to transmit of FIG. 11.

FIG. 13A is a first part of a flowchart of an exemplary method of operating a wireless communications device in accordance with an exemplary embodiment.

FIG. 13B is a second part of a flowchart of an exemplary method of operating a wireless communications device in accordance with an exemplary embodiment.

FIG. 14 is a flowchart of an exemplary method of operating a wireless communications device in accordance with an exemplary embodiment.

FIG. 15 is a drawing of an exemplary wireless communications device, e.g., a peer to peer wireless communications device, in accordance with an exemplary embodiment.

FIG. 16 is an assembly of modules which can, and in some embodiments is, used in the exemplary wireless communications device illustrated in FIG. 15.

FIG. 17 is a drawing of an exemplary wireless communications device, e.g., a peer to peer wireless communications device, in accordance with an exemplary embodiment.

FIG. 18 is an assembly of modules which can, and in some embodiments is, used in the exemplary wireless communications device illustrated in FIG. 17.

### DETAILED DESCRIPTION

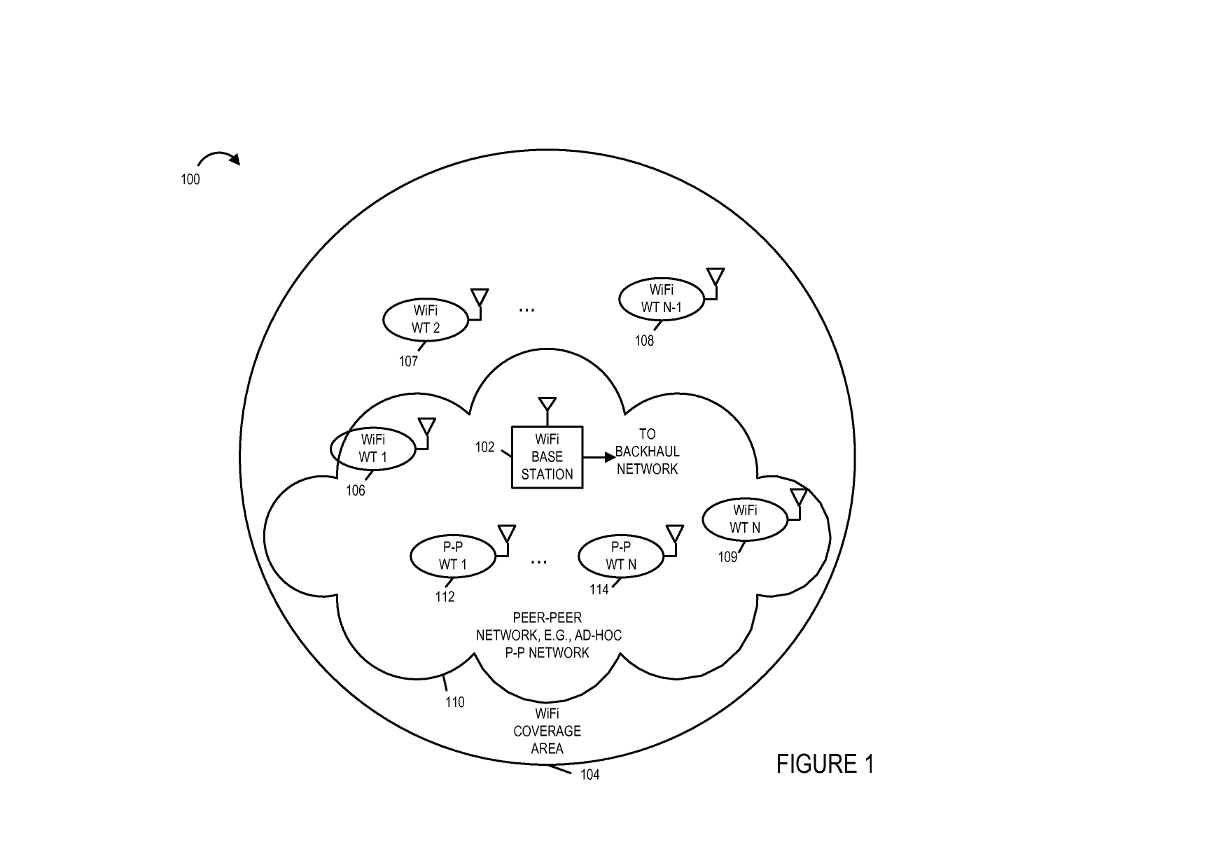

FIG. 1 is a drawing of an exemplary communications system 100 in accordance with an exemplary embodiment. Exemplary communications system 100 includes a WiFi base station 102 with a WiFi coverage area 104. Exemplary system 100 also includes a plurality of WiFi wireless terminals (WiFi wireless terminal 1 106, WiFi wireless terminal 2 107, . . . , WiFi wireless terminal (N−1) 108,WiFi wireless terminal N 109). Exemplary communications network 100 also includes a plurality of peer to peer wireless terminals (peer to peer wireless terminal 1 112, . . . , peer to peer wireless terminal N 114). The peer to peer wireless terminals (112, . . . , 114) are part of a peer to peer network, e.g., an ad-hoc peer to peer network. The peer to peer (112, . . . , 114) wireless terminals communicate with one another via direct device to device signaling.

The peer to peer wireless terminals (112, . . . , 114) use a communications protocol which is not compliant with WiFi. The peer to peer wireless terminals (112, . . . , 114) generate and transmit suppression signal, e.g., S-CTS signals, to suppress WiFi signaling so that the air link resource may be used for peer to peer communications within peer to peer communications network 110. An individual peer to peer wireless communications device, e.g., peer to peer wireless terminal 1 112, generates a signal suppression utility metric (SSUM) estimating an effectiveness of transmission of a signal used to suppress transmission by other devices, e.g., suppress Wi-Fi traffic signals by one or more of Wi-Fi devices (102, 106, 107, 108, . . . , 109). In various embodiments, the SSUM is based on the number of signal suppression signals, e.g., S-CTS signals, received from other peer to peer devices in a time period and/or the received power level of one or more received signal suppression signals. The peer to peer wireless communications devices makes a decision whether or not to transmit a signal suppression signal, e.g., a S-CTS signal, as a function of its generated SSUM. In various embodiments, a peer to peer wireless communications device selects a periodicity of transmission opportunities in which the peer to peer wireless communications will participate for the opportunity to transmit a transmission suppression signal as a function of its generated SSUM.

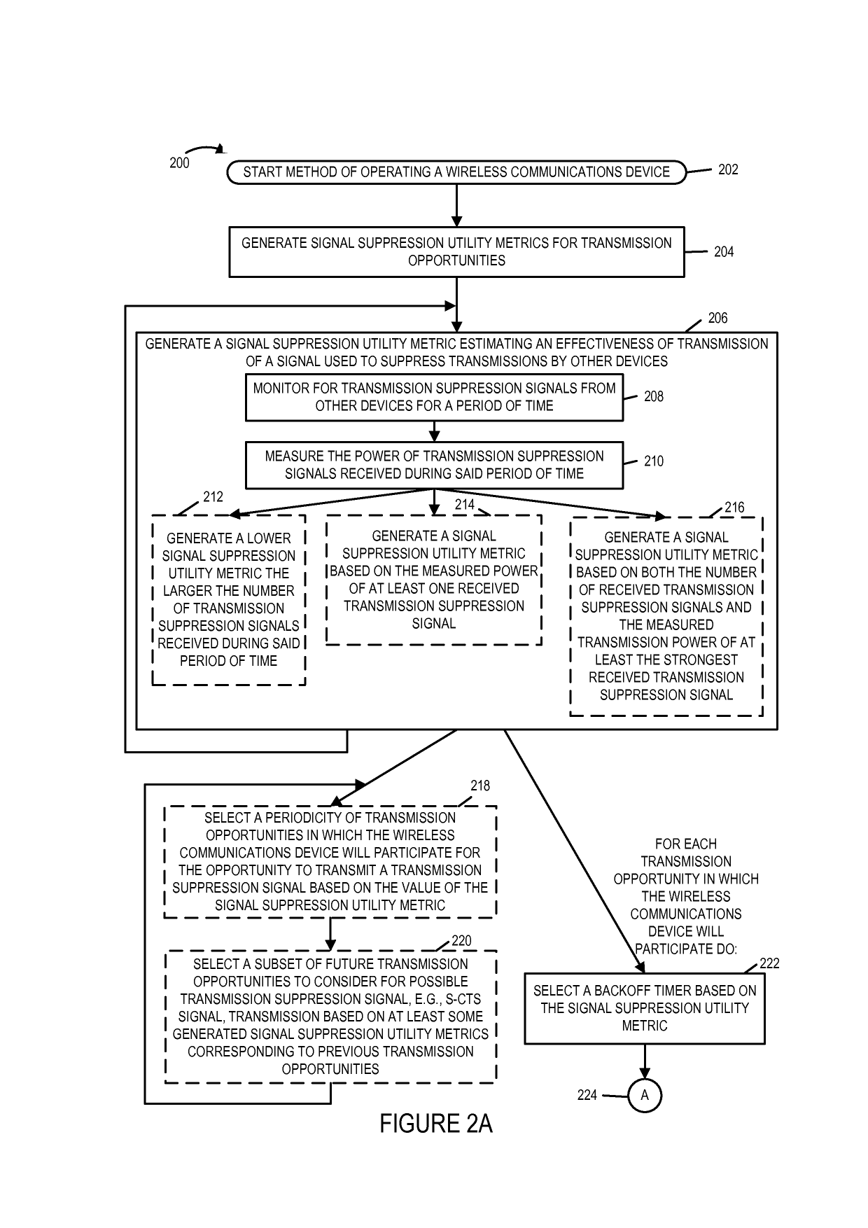

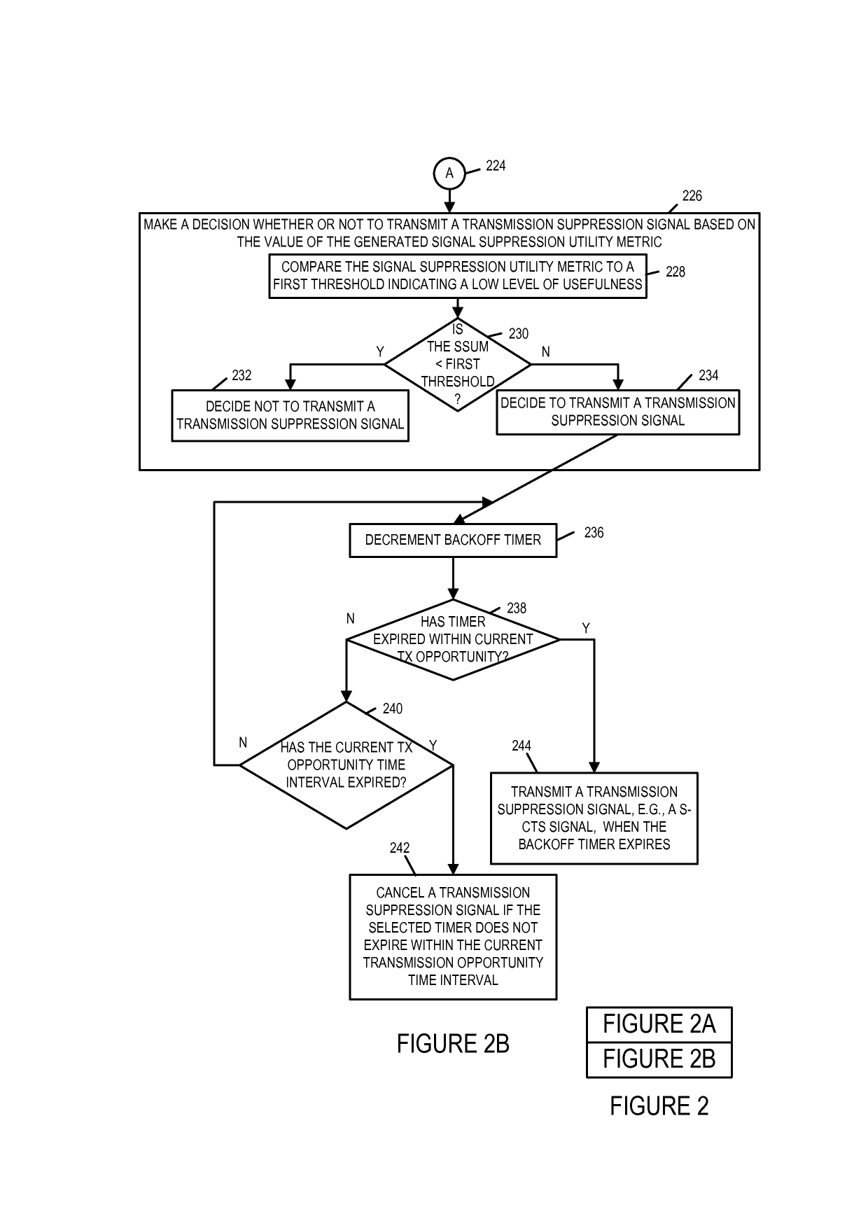

FIG. 2, comprising the combination of FIG. 2A and FIG. 2B, is a flowchart 200 of an exemplary method of operating a wireless communications device in accordance with various exemplary embodiments. The wireless communications device implementing the method of flowchart 200 is, e.g., one of the peer to peer wireless terminals (112, . . . , 114) of system 100 of FIG. 1. Operation starts in step 202 where the wireless communications device is powered on and initialized. Operation proceeds from start step 202 to step 204, in which the wireless communications device generates signal suppression utility metrics (SSUMs) for transmission opportunities. Operation proceeds from step 204 to step 206.

In step 206 the wireless communications device generates a signal suppression utility metric (SSUM) estimating an effectiveness of transmission of a signal used to suppress transmission by other devices. Step 206 includes step 208 and 210. In some embodiments, step 206 includes one or more or all of steps 212, 214 and 216. In step 208 the wireless communications device monitors for transmission suppression signals, e.g., S-CTS signals, from other devices for a period of time. Then, in step 210 the wireless communications device measures the power of transmission suppression signals received during said period of time. In step 212 the wireless communications device generates a lower signal suppression utility metric the larger the number of transmission suppression signals received during said time period. In step 214 the wireless communications device generates a signal suppression utility metric based on the measured power of at least one received transmission suppression signal. In some embodiments, in step 214 the wireless communications device generates a signal suppression utility metric (SSUM) based on a signal suppression utility metric (SSUM) function which uses the measured power of at least one received transmission suppression signal as an input and which produces a lower signal suppression utility metric (SSUM) value for a high received power level than for a low received power level. In step 216 the wireless communications device generates a signal suppression utility metric based on both the number of received transmission suppression signals and the measured transmission power of at least the strongest received transmission suppression signal. Operation proceeds from the output to step 206 back to the input of step 206, which is repeated, e.g., on a recurring basis. In some embodiments, operation also proceeds from step 206 to optional step 218. Operation also proceeds from step 206 to step 222.

Steps 218 and 220 are optional steps. In some embodiments, one or more of steps 218 and 220 are performed. A step which is not performed is bypassed. In step 218 the wireless communications device selects a periodicity of transmission opportunities in which the wireless communications device will participate for the opportunity to transmit a transmission suppression signal based on the value of the signal suppression utility metric. In some embodiments, the lower the SSUM the less frequent the transmission opportunities in which the device participates. Operation proceeds from step 218 to step 220. In step 220 the wireless communications device selects a subset of future transmission opportunities to consider for possible transmission suppression signal, e.g., S-CTS signal, transmission based on at least some generated signal suppression utility metrics corresponding to the previous transmission opportunities. For example, the wireless communications device selects a particular subset of recurring transmission opportunities, e.g., the wireless communications device selects the first one of each three transmission opportunities to consider for transmitting in. In some embodiments, a generated signal suppression utility metric (SSUM) of step 206 corresponds to a first one of a plurality of previous transmission opportunities and the generated SSUMs of step 204 correspond to additional previous transmission opportunities. Operation proceeds from step 220 to step 218. In various embodiments, the step 206 is performed at a different rate than the rate at which step 218 and 220 are performed. In some such embodiments, there are at least 10 iterations of step 206 for one iteration of the loop including one or more of steps 218 and 220.

The flow starting with step 222 is performed for each transmission opportunity in which the wireless communications device will participate. In some embodiments, the particular transmission opportunities in which the wireless communications device will participate is predetermined, e.g., based on a wireless communications device currently held identifier, or based on a group association to which the wireless communications device currently belongs. In some other embodiments, the particular transmission opportunities in which the wireless communications device will participate is based upon information derived from one or more of steps 218 and 220.

In step 222 the wireless communications device selects a backoff timer based on the signal suppression utility metric. The backoff timer is used in determining when to transmit the signal suppression signal during a transmission opportunity time interval. In some embodiments, the selected backoff timer is larger for a small SSUM indicating low usefulness than for higher SSUMs. Operation proceeds from step 222 via connecting node A 224 to step 226. In step 226 the wireless communications device makes a decision whether or not to transmit a transmission suppression signal, e.g., a S-CTS signal, based on the value of the generated signal suppression utility metric. In some embodiments, the transmission suppression signal is a S-CTS signal and the wireless communications device is a peer to peer communications device that uses a communications protocol which is not compliant with WiFi, and the WiFi is to be suppressed by transmission of the S-CTS signal. Step 226 includes steps 228, 230, 232 and 234. In step 228 the wireless communications device compares the signal suppression utility metric to a first threshold. Operation proceeds from step 228 to step 230. In step 230, if the signal suppression utility metric is less than the first threshold indicating a low level of usefulness, operation proceeds from step 230 to step 232, where the wireless communications device decides not to transmit a transmission suppression signal. However, if the signal suppression utility metric is greater than or equal to the first threshold, then operation proceeds from step 230 to step 234, in which the wireless communications device decides to transmit a transmission suppression signal.

Operation proceeds from step 234 to step 236. In step 236 the wireless communications device decrements the backoff timer in response to detecting that the communications channel being used is unoccupied for one or more predetermined periods of time. Operation proceeds from step 236 to step 238. In some embodiments, the selected backoff timer of step 222 can be selected to be 0. In such an embodiment step 236 is initially bypassed, with operation proceeding from step 234 to step 238.

In step 238 the wireless communications device determines if the backoff timer has expired within the current transmission opportunity time interval. If the backoff timer has expired then operation proceeds from step 238 to step 244 in which the wireless communications device transmits a transmission suppression signal, e.g., a S-CTS signal, when the backoff timer expires. However, if the backoff timer has not expired, then operation proceeds from step 238 to step 240, where the wireless communications device checks if the current transmission opportunity time interval has expired. If the current transmission opportunity time interval has expired, then operation proceeds from step 240 to step 242 where the wireless communications device cancels a transmission suppression signal since the selected backoff time did not expire within the current transmission opportunity time interval and the current transmission opportunity time interval has ended.

However, if the check of step 240 determined that the current transmission opportunity time interval has not expired then operation proceeds from step 240 to step 236.

In some embodiments, the wireless communications device estimates a fraction of the wireless communication device's decoding area covered by a received transmission suppression signal. In some such embodiments, the wireless communications device estimates a fraction of the wireless communication device's decoding area covered by a plurality of pertinent previously received transmission suppression signals. In some embodiments, the generated signal suppression utility metric of step 206 is generated as a function of the estimated fraction of the wireless communication device's decoding area covered by a plurality of previously received transmission suppression signals, e.g., a plurality of pertinent previously received transmission suppression signals over a predetermined time interval.

In various embodiments, the wireless communications device may, and sometimes does, transmit a peer to peer signal using an air link resource which is available due to a previously transmitted transmission suppression signal. In various embodiments, the wireless communications device may, and sometimes does, receive a peer to peer signal using an air link resource which is available due to a previously transmitted transmission suppression signal.

In some embodiments, the wireless communications device generating the SSUM and transmitting the transmission suppression signal uses a second communications protocol, e.g., a peer to peer communications protocol, and the devices which are being suppressed use a first communications protocol, e.g., a WiFi communications protocol. In some, but not necessarily all embodiments, some devices which use the first protocol do not support or include decoders corresponding to the second communications protocol. In some embodiments, devices which support the first protocol but not the second protocol are unable to decode signals transmitted in accordance with the second protocol. Some, but not necessarily all, devices which use and support the second protocol also support and use the first protocol.

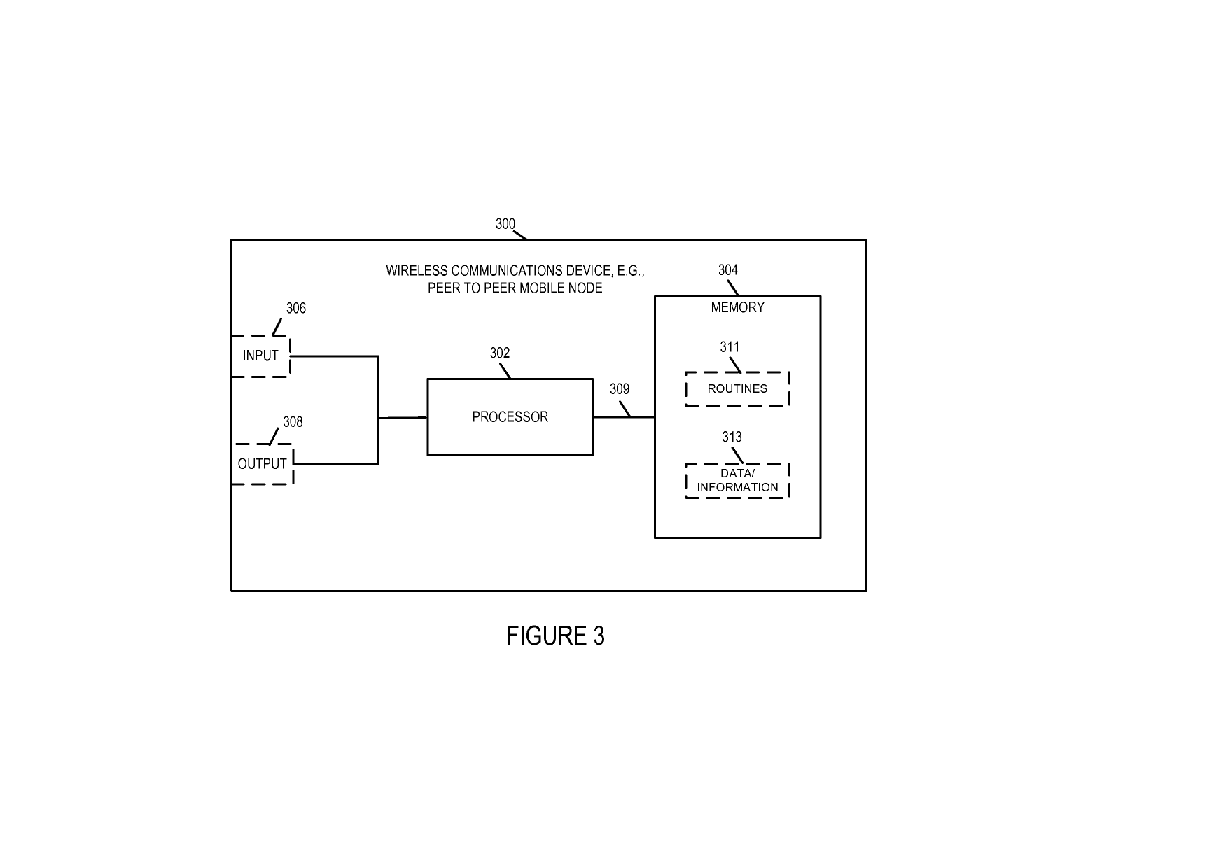

FIG. 3 is a drawing of an exemplary wireless communications device 300, e.g., a peer to peer mobile node, in accordance with an exemplary embodiment. Exemplary communications device 300 is, e.g., one of the peer to peer wireless communications devices (112, . . . , 114) of system 100 of FIG. 1. Exemplary wireless communications device 300 may, and sometimes does, implement a method in accordance with flowchart 200 of FIG. 2.

Wireless communications device 300 includes a processor 302 and memory 304 coupled together via a bus 309 over which the various elements (302, 304) may interchange data and information. Communications device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output. In some embodiments, memory 304 includes routines 311 and data/information 313.

In some embodiments, processor 302 is configured to: generate a signal suppression utility metric (SSUM) estimating an effectiveness of transmission of a signal used to suppress transmissions by other devices; and make a decision whether or not to transmit a transmission suppression signal based on the value of the generated SSUM.

In some embodiments, the transmission suppression signal is a S-CTS signal and the wireless communications device 300 is a peer-to-peer communications device. In some such embodiments, processor 302 is further configured to use a communications protocol which is not compliant with WiFi, which is to be suppressed by transmission of said S-CTS signal.

In various embodiments, processor 302 is configured to: monitor for transmission suppression signals, e.g. S-CTS signals, from other devices for a period of time; and measure the power of transmission suppression signals received during said period of time, as part of being configured to generating the SSUM (signal suppression utility metric).

Processor 302, in some embodiments, is configured to: generate a lower SSUM the larger the number of transmission suppression signals received during said period of time, as part of being configured to generating the SSUM (signal suppression utility metric). In some embodiments, processor 302 is configured to: generate a SSUM based on the measured power of at least one received transmission suppression signal, as part of being configured to generate the SSUM. In some such embodiments processor 302 is configured to generate a SSUM based on a SSUM function which uses the measured power of at least one received transmission suppression signal as an input and which produces a lower SSUM value for a high received power level than for a low received power level, as part of being configured to generate the SSUM. In various embodiments, processor 302 is configured to generate the SSUM based on both the number of received transmission suppression signals and the measured transmission power of at least the strongest received transmission suppression signal.

In some embodiments, processor 302 is further configured to: decide not to transmit a transmission suppression signal when the SSUM is below a first threshold indicating a low level of usefulness. In some such embodiments, processor 302 is further configured to: decide to transmit the transmission suppression signal when the SSUM equals or exceeds said first threshold.

Processor 302, in various embodiments, is further configured to: select a backoff timer based on said SSUM, said backoff timer being used in determining when to transmit said transmission suppression signal during a transmission opportunity time interval, the selected backoff time being larger for small SSUM indicating low usefulness than for higher SSUMs; and cancel a transmission suppression signal if the selected backoff timer does not expire within the current transmission opportunity time interval.

Processor 302, in some embodiments, is further configured to: select a periodicity of transmission opportunities in which the device will participate for the opportunity to transmit a transmission suppression signal based on the value of said SSUM, the lower the SSUM the less frequent the transmission opportunities in which the device participates.

In some embodiments, the said generated signal suppression utility metric corresponds to the first one of a plurality of previous transmission opportunities, and wherein processor 302 is further configured to: generate SSUMs for additional previous transmission opportunities; and select a subset of future transmission opportunities to consider for possible transmission suppression signal, e.g., S-CTS signal, transmission based on at least some generated SSUMs corresponding to previous transmission opportunities. For example, the wireless communications device 300 select a particular subset or recurring transmission opportunities, e.g., first of each 3 transmission opportunities, to consider transmitting in.

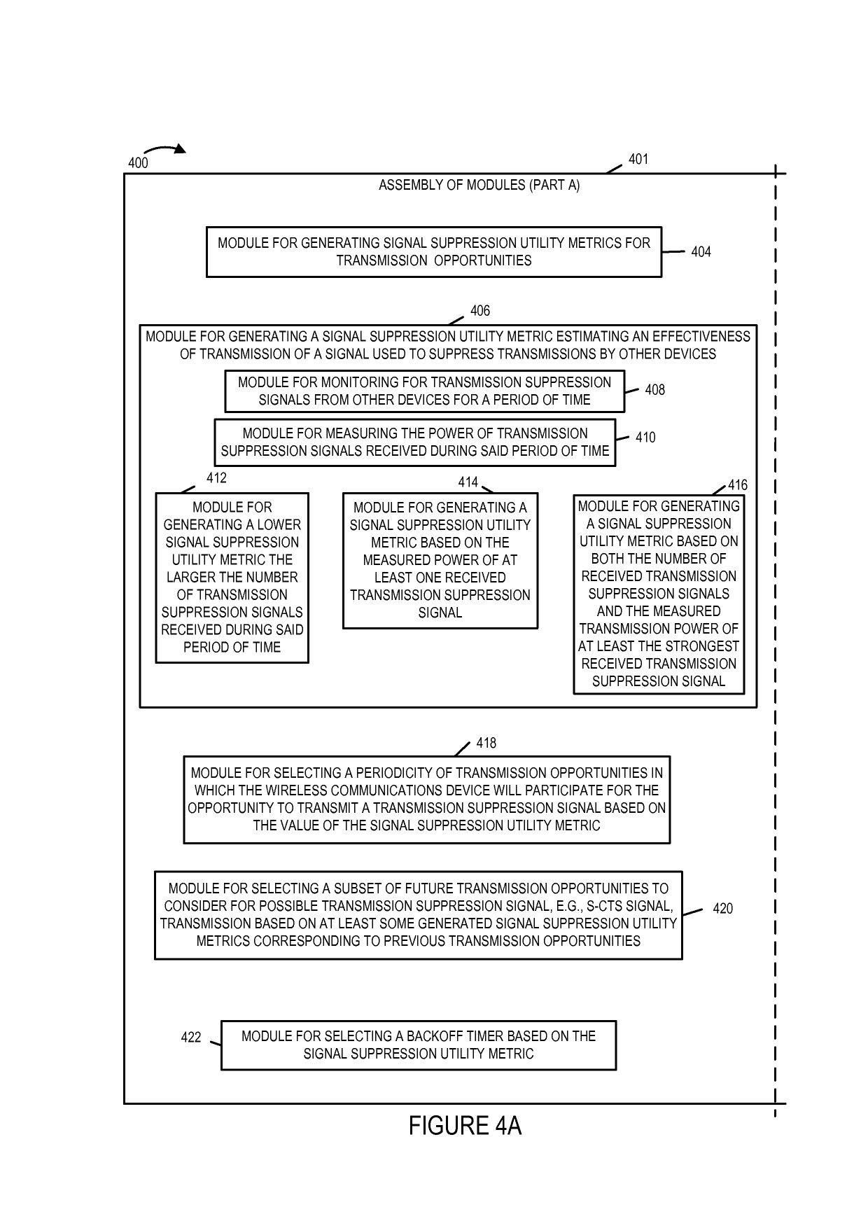

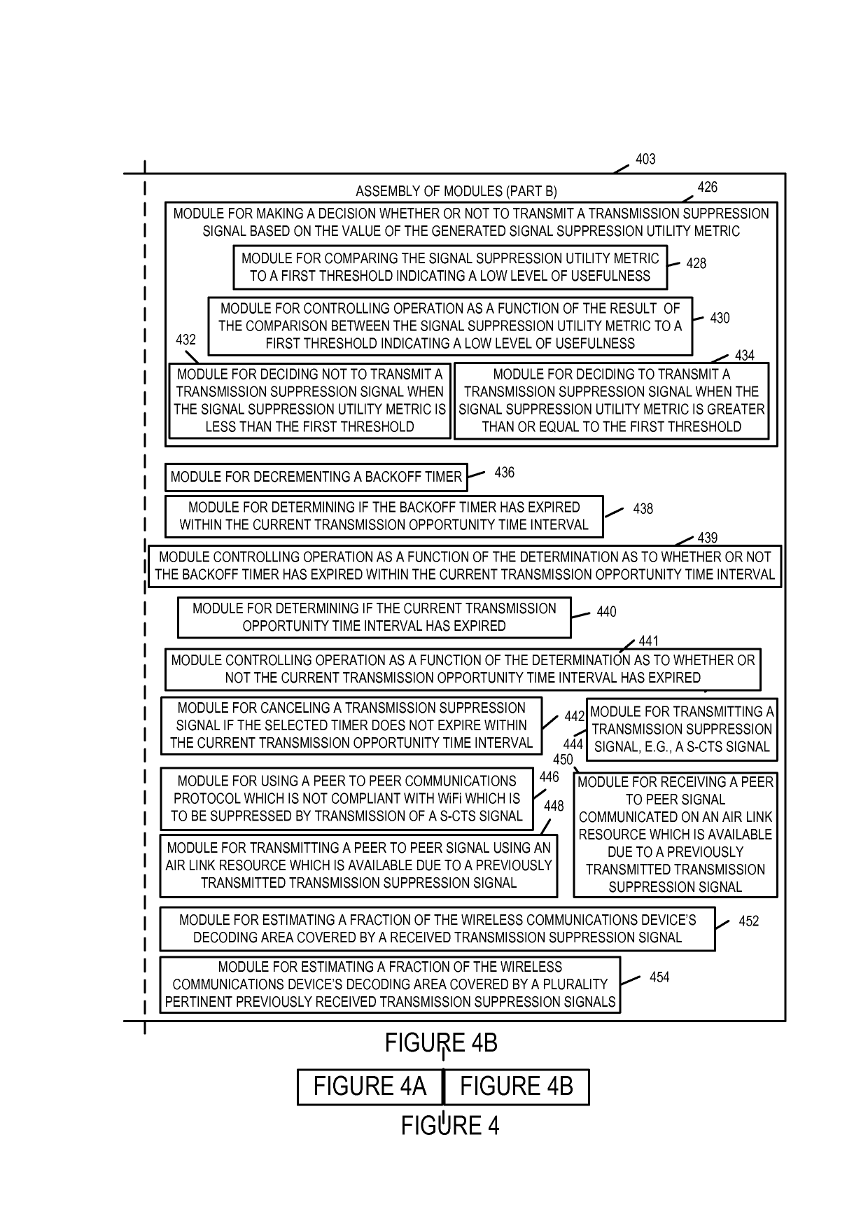

FIG. 4 is an assembly of modules 400 which can, and in some embodiments is, used in the exemplary wireless communications device 300 illustrated in FIG. 3. The modules in the assembly 400 can be implemented in hardware within the processor 302 of FIG. 3, e.g., as individual circuits. Alternatively, the modules may be implemented in software and stored in the memory 304 of wireless communications device 300 shown in FIG. 3. In some such embodiments, the assembly of modules 400 is included in routines 311 of memory 304 of device 300 of FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium, e.g., a non-transitory computer readable medium, comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the wireless communications device 300 or elements therein such as the processor 302, to perform the functions of the corresponding steps illustrated and/or described in the method of flowchart 200 of FIG. 2.

Assembly of modules 400 includes part A 401 and part B 403. Assembly of modules 400 includes a module of generating signal suppression utility metrics for transmission opportunities, e.g., for additional previous transmission opportunities, 404, a module for generating a signal suppression utility metric estimating an effectiveness of transmission of a signal used to suppress transmissions by other devices 406, a module for selecting a periodicity of transmission opportunities on which the wireless communications device will participate for the opportunity to transmit a transmission suppression signal based on the value of the signal suppression utility metric 418, a module for selecting a subset of future transmission opportunities to consider for possible transmission suppression signal, e.g., S-CTS signal, transmission based on at least some generated signal suppression utility metrics corresponding to previous transmission opportunities 420 and a module for selecting a backoff timer based on the signal suppression utility metric 422.

In various embodiments, the backoff timer is used in determining when to transmit the transmission suppression signal during a transmission opportunity time interval. In some such embodiments, the selected backoff timer, selected by module 422 is larger for a small SSUM, indicating a low usefulness, than for a higher SSUM. For example, there is an inverse relationship between SSUM value and the corresponding selected backoff timer value.

In some embodiments, module 418 selects periodicity such that the lower the SSUM the less frequent the transmission opportunities in which the wireless communications device will participate.

Module 406 for generating as signal suppression utility metric includes a module for monitoring for transmission suppression signals from other devices for a period of time 408, a module for measuring the power of transmission suppression signals received during said period of time 410, a module for generating a lower signal suppression utility metric the larger the number of transmission suppression signals received during said time period 412, a module for generating a signal suppression utility metric based on the measured power of at least one received transmission suppression signal based 414, and a module for generating a signal suppression utility metric based on both the number of received transmission suppression signals and the measured transmission power of at least the strongest received transmission suppression signal 416. In some embodiments, module 414 generates a signal suppression utility metric (SSUM) based on a signal suppression utility metric (SSUM) function which uses the measured power of at least one received transmission suppression signal as an input and which produces a lower signal suppression utility metric (SSUM) value for a high received power level than for a low received power level.

Assembly of modules 400 further includes a module for making a decision whether or not to transmit a transmission suppression signal based on the value of the generated signal suppression utility metric 426, a module for decrementing a backoff timer 436, a module for determining if the backoff time has expired within the current transmission opportunity time interval 438, a module for controlling operation as a function of the determination as to whether or not the backoff time has expired within the current transmission opportunity time interval 439, a module for determining if the current transmission time interval has expired 440, a module for controlling operation as a function of the determination as to whether or not the current transmission opportunity time interval has expired 441, a module for canceling a transmission suppression signal if the selected timer does not expire within the current transmission opportunity time interval 442, a module for transmitting a transmission suppression signal, e.g., a S-CTS signal 444, and a module for using a peer to peer communications protocol which is not compliant with WiFi which is to be suppressed by transmission of a S-CTS signal. Module 426 includes a module for comparing the signal suppression utility metric to a first threshold indicating a low level of usefulness 428, a module for controlling operation as a function of the result of the comparison between the signal suppression utility metric to a first threshold indicating a low level of usefulness 430, a module for deciding not to transmit a transmission suppression signal when the signal suppression utility metric is less than a first threshold indicating a low level of usefulness 432 and a module for deciding to transmit a signal suppression utility metric when the signal suppression utility metric is greater than or equal to a first threshold 434.

Assembly of modules 400 further includes a module for transmitting a peer to peer signal using an air link resource which is available due to a previously transmitted transmission suppression signal 448. In some embodiments, the peer to peer signal is a broadcast signal. In some embodiments, the peer to peer signal is a peer discovery signal. In some embodiments, the previously transmitted transmission suppression signal is a S-CTS signal. In some embodiments, the previously transmitted suppression signal was transmitted by the wireless communications device including assembly of modules 400. In some embodiments, the previously transmitted suppression signal was transmitted by a different wireless communications device than the wireless communications device transmitting the peer to peer signal, e.g., a wireless communications device in the local vicinity of the wireless communications device transmitting the peer to peer signal. In some embodiments, the received peer to peer signal is a broadcast signal. In some embodiments, the received peer to peer signal is a peer discovery signal. In some embodiments, the previously transmitted suppression signal was transmitted by a different wireless communications device than the wireless communications device transmitting the peer to peer signal, e.g., a wireless communications device whose transmitted transmission suppression signal was detected by the wireless communications device transmitting the peer to peer signal.

Assembly of modules 400 further includes a module for receiving a peer to peer signal communicated on an air link resource which is available due to a previously transmitted transmission suppression signal 450. The previously transmitted transmission suppression signal may have been transmitted by the wireless communications device which transmitted the peer to peer signal or by another wireless communications device.

Assembly of modules 400 further includes a module for estimating the fraction of the wireless communications device's decoding area covered by a received transmission suppression signal 452 and a module for estimating the fraction of the wireless communications device's decoding area covered by a plurality of pertinent previously received transmission suppression signals 454. In some embodiment's module 452 and module 454 are used by module 406 to generate a SSUM. In some embodiments, the generated SSUM is a function of estimated fraction of decoding area from module 454. In some embodiments, pertinent previously received transmission suppression signals from module 454's perspective correspond to a transmission suppression signaling opportunities which are of interest to the wireless communications device, e.g., opportunities in which the wireless communications device may participate.

In some embodiments, the transmission suppression signal is a S-CTS signal and the wireless communications device including assembly of modules 400 is a peer to peer communications device that uses a communications protocol that is not compliant with WiFi, which is to be suppressed by transmission of the S-CTS signal. In some embodiments, the transmission suppression signal is a S-CTS signal which is a CTS to self signal.

Various aspects and/or features of some embodiments will be further discussed. To coexist with the incumbent 802.11 (WiFi) networks in the unlicensed spectrum, it is sometimes useful if the other technologies time orthogonalize with the 802.11 devices. This can also be beneficial in the case for the newer versions of 802.11 protocols that are not backward compatible with the legacy 802.11 devices. This time orthogonalization, in some embodiments, is achieved by devices following one protocol by transmitting a message that the devices following a different protocol (viz. WiFi) can interpret and refrain from transmissions for certain duration in response to the transmitted message.

In case of coexistence with WiFi/legacy WiFi devices, in some embodiments, the devices with other protocols transmit CTS packets addressed to a special MAC ID that identifies the network with other protocol. These packets carry NAV that allocates a time interval in which the devices with the other protocol can transmit while the WiFi/legacy WiFi devices remain silent. The special destination MAC ID as well as the frame control field helps the devices in the non-WiFi network identify the special CTS (S-CTS) packets and disregard NAV it carries.

Consider a time synchronous network that follows a PHY-MAC protocol other than WiFi/legacy WiFi protocol. Further consider that the devices in this network have a common notion of periodic traffic time intervals in which they should transmit their packets as per their protocol. To silence the WiFi/legacy WiFi devices during these intervals, the devices, in some embodiments, transmit S-CTSs in an interval that precedes the traffic intervals. It is beneficial if the devices in the synchronous network maximize the number of successful decoders of S-CTS packets. It is also desirable that the decoders of S-CTS packets are evenly spread in the space to avoid dead zones where the devices in the synchronous network cannot transmit or see WiFi interference. If each of the devices in the synchronous network contends to transmit S-CTS, the S-CTS collisions will increase. It also increases the power consumption of the synchronous devices and impacts the battery life adversely. Moreover, some of the S-CTS transmissions may be redundant as the other devices in the same neighborhood may have already transmitted S-CTS and silenced the WiFi/legacy WiFi devices.

In some embodiments, the devices dynamically decide whether to transmit S-CTS or not based on the prior S-CTS transmissions. This approach reduces the redundant S-CTS transmission and thereby reduces the collisions.

In some embodiments, in order to suppress WiFi signals in order to allow the frequency spectrum to be used briefly for communication using an alternative communications protocol, e.g. non-WiFi peer to peer communications protocols, a S-CTS (Special Clear To Send) signal is sent which is detected and treated as a CTS signal by the WiFi devices. Transmission of S-CTS signals by multiple non-WiFi devices can result in collisions of the signals in which case they may be ineffective. Furthermore, the transmission of a S-CTS signal consumes transmission power which it is desirable to conserve given the normally limited amount of battery power available to peer-to-peer devices which are likely to transmit such signals to allow for the use of non-WiFi peer-to-peer communication, e.g., non-WiFi peer to peer traffic signals.

In accordance with various features a signal suppression utility metric (SSUM) is generated. The signal suppression utility metric provides an indication of how useful transmitting a S-CTS signal will be at a given point in time. The signal suppression utility metric (SSUM) takes into consideration one or more of the following: the effective coverage area of a transmitted S-CTS signal, the probability that the S-CTS signal will result in suppression of signals which would not be suppressed absent transmission of the S-CTS signal and/or the probability that the S-CTS signal if transmitted will collide with another S-CTS signal and be ineffective. Various features are directed to generation of a useful signal suppression utility metric (SSUM) while other features are directed to using a generated SSUM to determine whether or not to transmit a S-CTS signal at a particular point in time. The SSUM may be generated based on one or more of the following: i) the strength of one or more S-CTS signals received from other devices; 2) how many S-CTS signals from other devices are received in a period of time; and 3) a combination of how many S-CTS signals are received in a period of time along with the strength of one or more such signals. As should be appreciated receipt of one or more strong S-CTS signals indicates that the coverage area to be covered by a S-CTS signal, if transmitted, will be similar to the coverage area already covered by the S-CTS signal being transmitted by the other device. Receiving a large number of S-CTS signals indicates that the benefit of an additional S-CTS transmission is likely to be small and/or be counterproductive by resulting in S-CTS signal collisions.

In some embodiments, if the SSUM for a given S-CTS transmission opportunity is low, the device generating the SSUM does not transmit the S-CTS signal or selects a longer backoff for S-CTS transmission control than would be selected given a higher SSUM indicating that transmission of an S-CTS signal would be productive. If the S-CTS signal is not transmitted due to a backoff in the corresponding S-CTS transmission window the transmission is canceled and not transmitted at the expiration of the selected backoff transmission timer.

Rather than canceling a S-CTS transmission or being used to select a long backoff timer, the SSUM can be used to control how many S-CTS transmission opportunities a device participates in relative to the total number of such opportunities. Thus, the SSUM can control the periodicity of S-CTS transmission attempts. For example a low SSUM indicating low usefulness of S-CTS transmission may result in the device choosing to participate in every 1/Nth S-CTS transmission opportunity, e.g., every 3rd or 4th transmission opportunity rather than every S-CTS transmission opportunity.

In some embodiments a device only participates in 1/N S-CTS transmission opportunities and the S-CTS transmission is canceled if it is not completed in the particular S-CTS transmission opportunity (WiFi CTS transmission opportunity period) in which the device decides to attempt the S-CTS transmission.

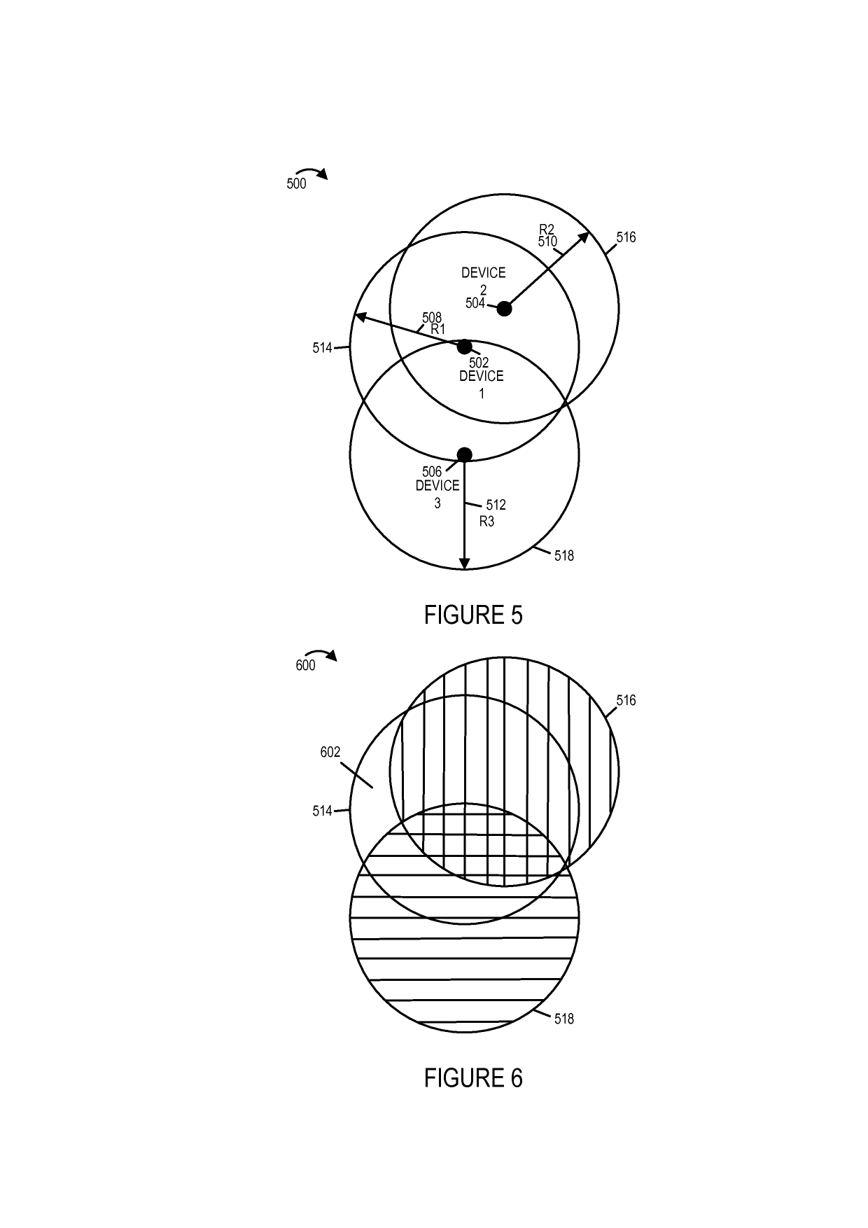

In some embodiments, a device, e.g., a peer to peer wireless communications device using a non-WiFi peer to peer communications protocol, transmits a S-CTS to silence the WiFi devices within the decoding range from itself. Drawing 500 of FIG. 5 illustrates three exemplary devices (device 1 502, device 2 504, device 3 506) which may, and sometimes do, transmit S-CTS signals to silence WiFi devices in their vicinity. Device 1 502 has a corresponding decoding area of its transmission, which is represented as circle 514 centered at device 1 502. Decoding area 514 corresponds to decoding range R1 508. Device 2 504 has a corresponding decoding area of its transmission, which is represented as circle 516 centered at device 2 504. Decoding area 516 corresponds to decoding range R2 510. Device 3 506 has a corresponding decoding area of its transmission, which is represented as circle 518 centered at device 3 506. Decoding area 518 corresponds to decoding range R3 512. In some embodiments R1 =R2 =R3. In some such embodiments, the S-CTSs signals transmitted from device 1 502, device 2 504 and device 3 506, when transmitted are transmitted at the same power level.

When the devices in the neighborhood of device 1 502, e.g., device 2 504 and device 3 506 transmit S-CTS, they silence legacy WiFi devices in a fraction of the decoding area of device 1 502. Depending on the proximity of S-CTS transmitters and no. of S-CTS transmissions in the neighborhood, most of the decoding area of a device may, and sometimes is, covered. In such a case, the utility of S-CTS of that device is low. In various embodiments, in such a situation, the device does not transmit a redundant S-CTS to avoid collisions. FIG. 6 illustrates an example, in which device 2 504 and device 3 506 transmit S-CTS signals, and legacy WiFi devices are silenced most of the decoding area 514 of device 1 502. WiFi devices in the entire region of decoding area 514 are silenced with the exception of the small unshaded area 602.

In some embodiments, a wireless communications device estimates the utility of a S-CTS transmission. In some such embodiments, a wireless communications device can, and sometimes does, estimate the utility of its transmission based on one or more or all of the following metrics : (i) the power of the strongest received S-CTS signal, (ii) the number of S-CTS signals received; and (iii) a utility metric that estimates the decoding area covered by the received S-CTS signals.

In some embodiments, the power of the strongest S-CTS received is used as a metric to estimate the utility of transmitting a S-CTS signal. For example, a device can, and in some embodiments does, estimate the distance from the nearest neighbor based on the received power of the S-CTS transmission from the nearest neighbor. In some such embodiments, the utility of a device's S-CTS transmission is a monotonically increasing function of the distance from the nearest neighbor. In other words, utility of the device's S-CTS transmission is a monotonically decreasing function of the power of the strongest S-CTS received.

In some embodiments, the number of S-CTS packets received is used as a metric to estimate the utility of transmitting a S-CTS signal. For example, the utility of the device's S-CTS transmission is a monotonically decreasing function of the number of S-CTS packets received.

In some embodiments, a utility metric that estimates the decoding area covered by received S-CTS transmissions is used as a metric to estimate the utility of transmitting a S-CTS signal. A device can, and in some embodiments, does estimate the decoding area covered by the S-CTS transmissions that it receives. One such example is provided below. A device estimates its own decoding range R, and hence decoding area, based on the decoding SNR required for S-CTS packet assuming a path loss model. For example, consider that a device uses the following model to estimate path loss.

Path loss at distance d (m) is given by:

Path loss (dB)=k+alpha*log(d)
K=28.6
Alpha=35

The device maintains an estimate of the fraction of its decoding area covered so far, M, and updates the estimate after each S-CTS reception. Initialize M=0. After decoding i^{th} S-CTS the device performs the following steps. The device estimates the distance of the transmitter dᵢ based on the received power using the assumed path loss model. Based on dᵢ and R, the device estimates the fraction of the decoding area covered by the received S-CTS. Let fᵢ denote that fraction. The device updates the estimate of M based on fᵢ as follows:

M=M+fᵢ−M*fᵢ.

Since a device does not know the locations of the S-CTS transmitters, the above equation assumes that the location of the i^{th} transmitter is independent of the previous transmitters. In some embodiments, the time intervals that S-CTSs cover via NAV may, and sometimes does, differ with different S-CTS transmissions. In one such embodiment, the device updates the estimate of M after receiving the S-CTS packets that cover the time interval the device intends to cover by its S-CTS. In some embodiments, the utility of S-CTS transmission is a monotonically decreasing function of M.

Exemplary S-CTS utility metric incorporation in the decision as to whether or not the device is to transmit an S-CTS signal will be described. Since S-CTS is a broadcast packet and there are no ACKs/Nacks associated with it. The transmitters cannot adapt the back off window based on the Acks. In some embodiments, a device intending to transmit an S-CTS signal picks a back off based on its estimate of the contenders and the utility of its own transmission. In particular, a device can follow one of the following schemes.

In one exemplary embodiment, the device picks a random back off for S-CTS transmission based on its estimate of the contending nodes. The estimated contenders are, e.g., the number of peers discovered in a peer discovery cycle. The device maintains and updates the utility of its S-CTS after each S-CTS reception and cancels the transmission if the utility is below a certain threshold.

In another embodiment, after each S-CTS reception, the device updates the utility of its S-CTS. In some embodiments, the device picks a new back off after each S-CTS reception. In some embodiments, the new back off is proportional to its estimate of the contenders. In some embodiment, the new back off is inversely proportional to the utility of its S-CTS.

In some embodiments, the devices in the synchronous network time orthogonalize. Note that even though the network is synchronous, it is not possible to have a TDM scheme to transmit S-CTSs as a device needs to carrier sense before transmitting an S-CTS signal and the start of a S-CTS transmission may, and sometimes does, vary due to the channel being busy at times. Hence the time orthogonalization is coarse and the subset of the devices that attempt to transmit S-CTS in a S-CTS transmission interval still contend with each other. The details of a proposed solution used in some embodiments are as follows.

In some embodiments, a device determines periodicity to transmit a S-CTS signal. In some such embodiments, when a device joins the synchronous network, it picks periodicity to attempt to transmit S-CTS. In some such embodiments, the device chooses to transmit in one out of N S-CTS durations. In some embodiments, N is fixed across the network and can be related to the periodicity with which the device transmits in the traffic intervals. In some embodiments, N is based on a device's estimation of the number of devices transmitting in a logical periodic channel such as traffic channel, peer discovery channel, etc. In some such embodiments, N is proportional to the device's estimate of total number of devices in the network. This approach tends to keep the number of devices contending to transmit S-CTS roughly constant.

In some embodiments, a device determines a S-CTS transmission interval in which to contend. In some such embodiments, a device chooses one S-CTS transmission interval out of N S-CTS intervals in one of the following ways. (a) The index of the S-CTS interval can be pseudo-random and can be function of time and the transmitter's MAC ID. (b) In some embodiments using a fixed N across the network, the device chooses the S-CTS interval which precedes the traffic interval in which it is scheduled to transmit. (c) The device monitors the S-CTS intervals before picking the interval to contend in and chooses the S-CTS transmission interval in which its S-CTS transmission is most useful. The utility of S-CTS transmission in some embodiments is determined based on one or more or all of the following: (i) the number of S-CTS transmissions received in the interval, (ii) the maximum power of S-CTS transmission received in the interval.

A device transmits S-CTS in the determined S-CTS transmission interval. In some embodiments, the device follows WiFi protocol to determine when it should transmit during the S-CTS transmission interval. It senses the channel to determine if it is free. If the channel is free, it waits for an IFS period and a random back off before transmitting the S-CTS packet. The device can further reduce collisions by randomizing the time when it begins to sense the channel.

A device cancels an intended S-CTS transmission in a busy interval. If the back off does not expire in the chosen interval or if there is not enough time left in the S-CTS transmission interval to finish the transmission, the device cancels the intended S-CTS transmission during that interval, i.e., the S-CTS transmission interval does not extend in time based on carrier sense procedure. In some embodiments, a device picks a new back off for the next S-CTS transmission interval in which it contends. In some embodiments, a device freezes the current back off and decrement it in the next S-CTS transmission interval.

In some embodiments, a device monitors the network on a slower time scale. For example, the device monitors the network on a slower time scale to detect the changes in the network topology. It updates the periodicity and S-CTS transmission interval based on the monitored changes.

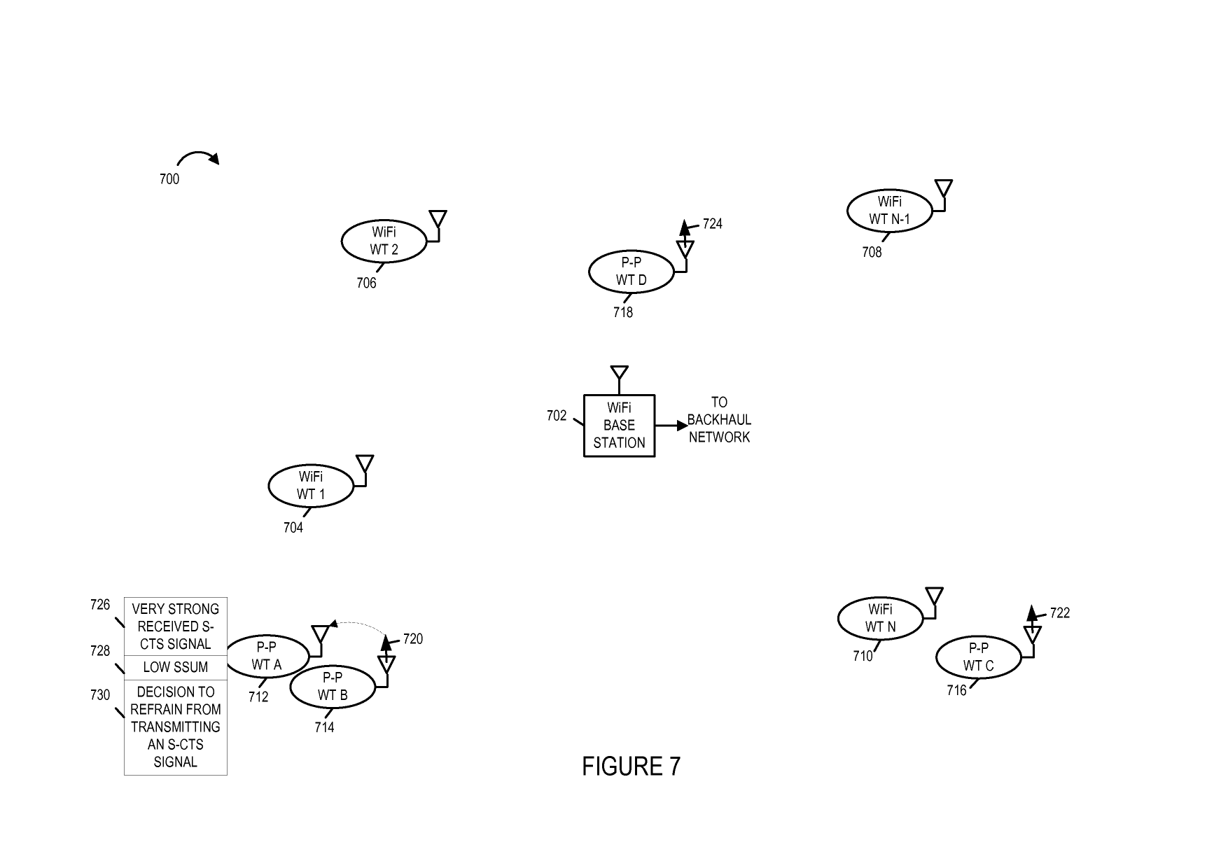

FIGS. 7-12 illustrates several examples in which a peer to peer wireless communications device generates a signal suppression utility metric and makes a decision whether or not to transmit a transmission suppression signal based on the value of the generated signal suppression utility metric in accordance with an exemplary embodiment. Drawing 700 illustrates a plurality of WifI devices (WiFi base station 702, WiFi wireless terminal 1 704, WiFi wireless terminal 2 706, WiFi wireless terminal N−1 708, WiFi WT N 710) and a plurality of peer to peer wireless terminal (peer to peer wireless terminal A 712, peer to peer wireless terminal B 714, peer to peer wireless terminal C 716, peer to peer wireless terminal D 718). The devices FIG. 7 are, e.g., devices of system 100 of FIG. 1. In some embodiments peer to peer WT A 712 is wireless communications device 300 of FIG. 3. The peer to peer devices transmit transmission suppression signal, which are S-CTS signals, to suppress WiFi transmission so that air link resources normally used for WiFi can be used by the peer to peer network.

In the example, of FIG. 7, peer to peer WT B 714 transmits S-CTS signal 720; peer to peer WT C 716 transmits S-CTS signal 722; and peer to peer WT D 718 transmits S-CTS signal 724. Peer to peer WT A 712 which has been monitoring for transmission suppression signals from other peer to peer devices receives signal 720 and determines that its received power level indicates that it is a very strong signal, e.g., above a threshold level identifying very strong signals, as indicated by block 726. P-P WT A 712 generates a signal suppression utility metric (SSUM) as a function of the receive power level of signal 720. In this example, the SSUM is a low value, e.g., below a predetermined threshold, as indicated by block 728. P-P WT A 712 makes a decision to refrain from transmitting an S-CTS signal, as indicated by block 730, based on the value of the generated SSUM.

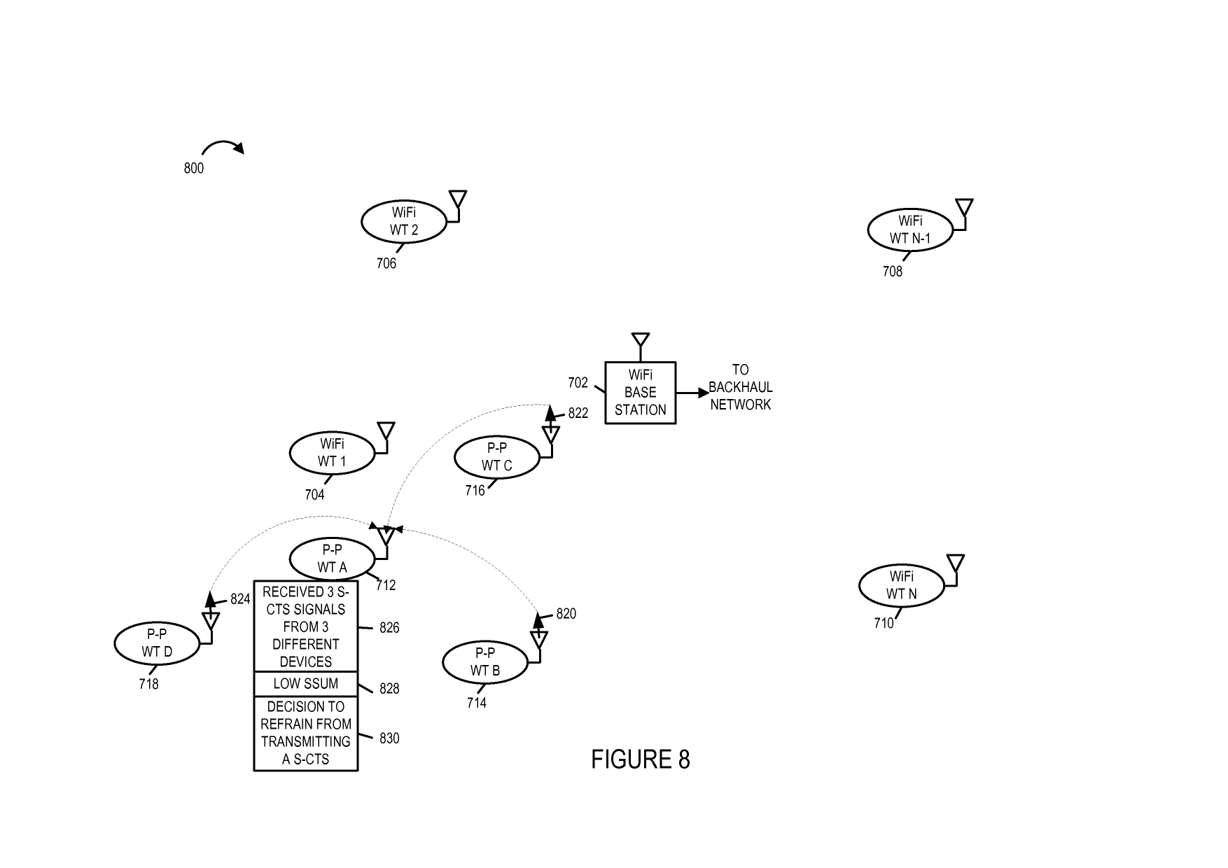

In the example, of FIG. 8 in drawing 800, peer to peer WT B 714 transmits S-CTS signal 820; peer to peer WT C 716 transmits S-CTS signal 822; and peer to peer WT D 718 transmits S-CTS signal 824. Peer to peer WT A 712 which has been monitoring for transmission suppression signals from other peer to peer devices receives signals 820, 822 and 824 and determines that it has a received 3 S-CTS signals from three different peer to peer wireless communications devices, as indicated by block 826. P-P WT A 712 generates a signal suppression utility metric (SSUM) as a function of the number of detected signal suppression signals. In this example, the SSUM is a low value, e.g., below a predetermined threshold, as indicated by block 828. P-P WT A 712 makes a decision to refrain from transmitting an S-CTS signal, as indicated by block 830, based on the value of the generated SSUM.

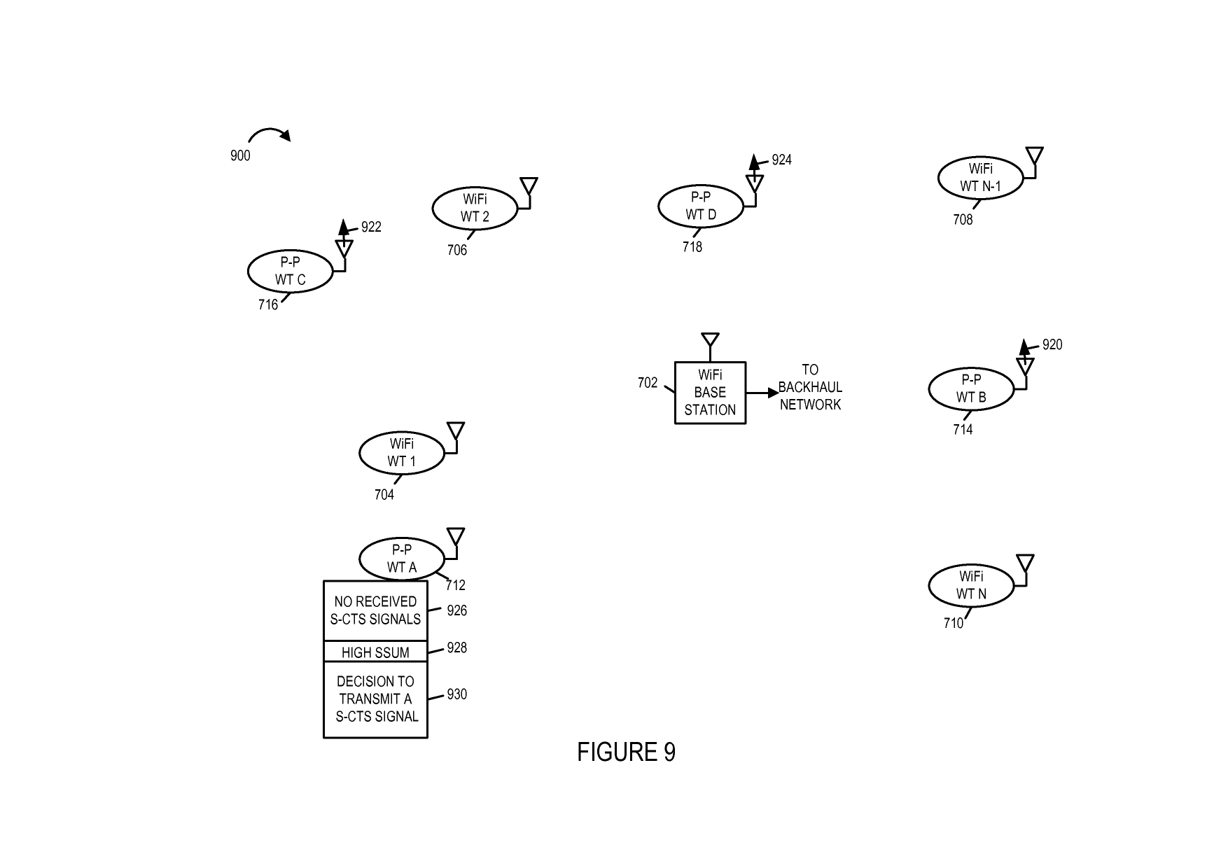

In the example, of FIG. 9 in drawing 900, peer to peer WT B 714 transmits S-CTS signal 920; peer to peer WT C 716 transmits S-CTS signal 922; and peer to peer WT D 718 transmits S-CTS signal 924. Peer to peer WT A 712 which has been monitoring for transmission suppression signals does not detect any signals as indicated by block 926. P-P WT A 712 generates a signal suppression utility metric (SSUM) as a function of the number of detected signal suppression signals. In this example, the SSUM is a high value, e.g., above a predetermined threshold, as indicated by block 928. P-P WT A 712 makes a decision to transmit a S-CTS signal, as indicated by block 930, based on the value of the generated SSUM.

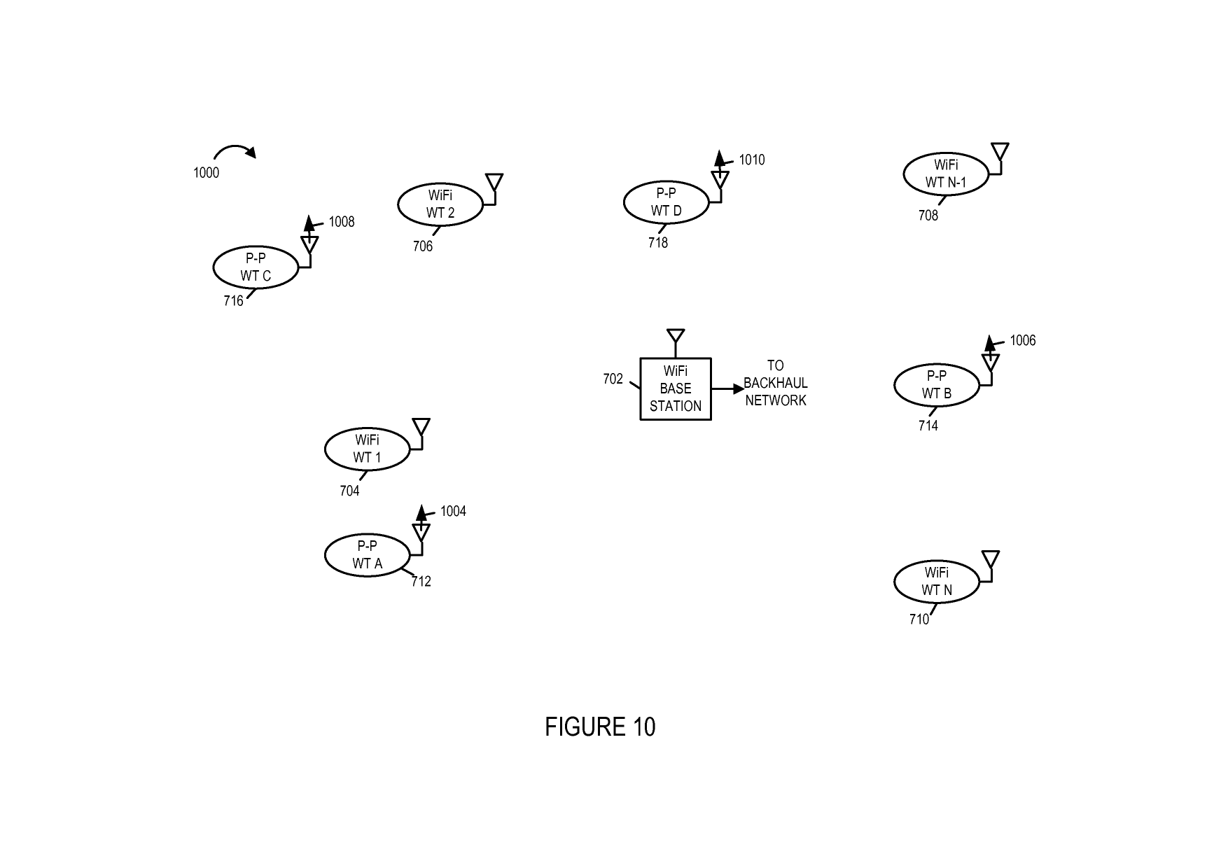

In the example, of FIG. 10 in drawing 1000, peer to peer WT A 712 transmits S-CTS signal 1004, in response to the decision of block 930 of FIG. 9; peer to peer WT B 714 transmits S-CTS signal 1006; peer to peer WT C 716 transmits S-CTS signal 1008; and peer to peer WT D 718 transmits S-CTS signal 1010.

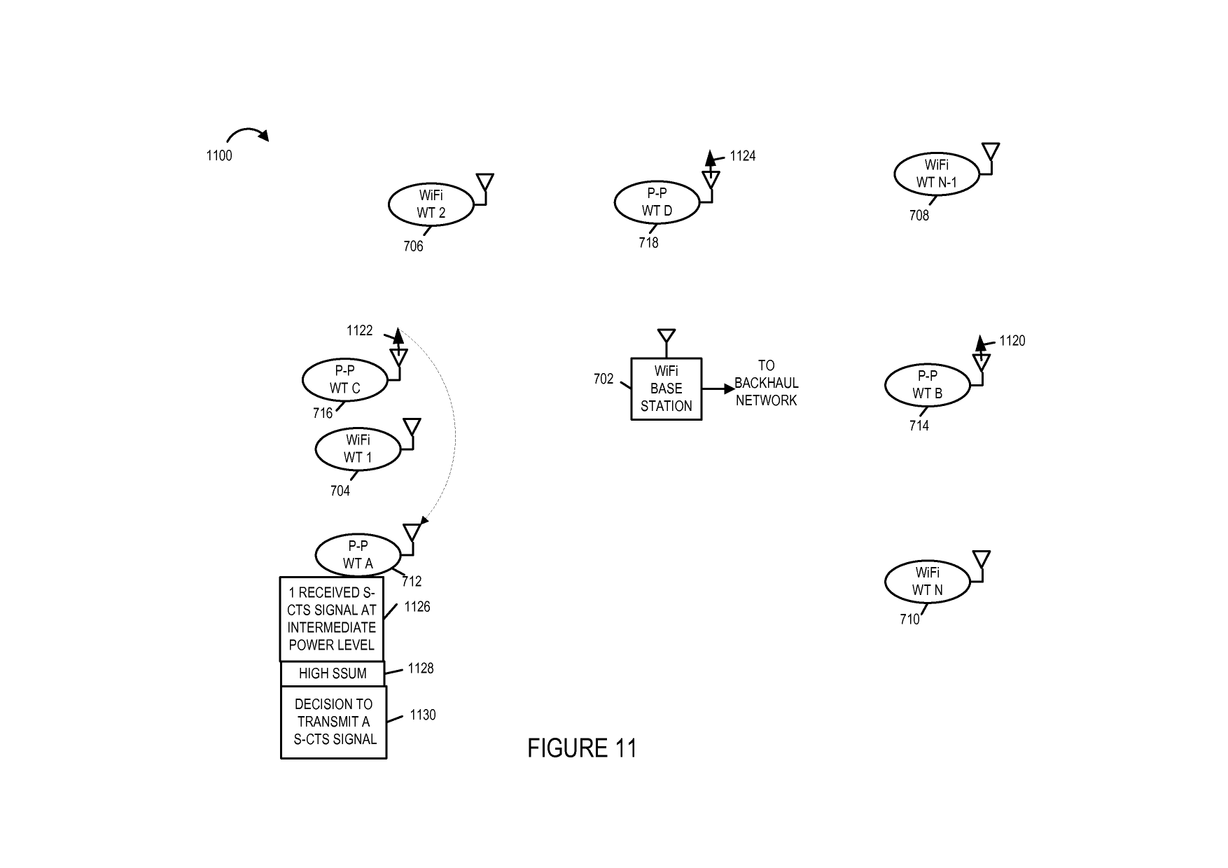

In the example, of FIG. 11 in drawing 1100, peer to peer WT B 714 transmits S-CTS signal 1120; peer to peer WT C 716 transmits S-CTS signal 1122; and peer to peer WT D 718 transmits S-CTS signal 1124. Peer to peer WT A 712 which has been monitoring for transmission suppression signals detect one S-CTS signal, signal 1122, at an intermediate power level as indicated by block 1126. P-P WT A 712 generates a signal suppression utility metric (SSUM) as a function of the number of detected signal suppression signals and the received power level of the detected transmission suppression signals. In this example, the SSUM is a high value, e.g., above a predetermined threshold, as indicated by block 1128. P-P WT A 712 makes a decision to transmit a S-CTS signal, as indicated by block 1130, based on the value of the generated SSUM.

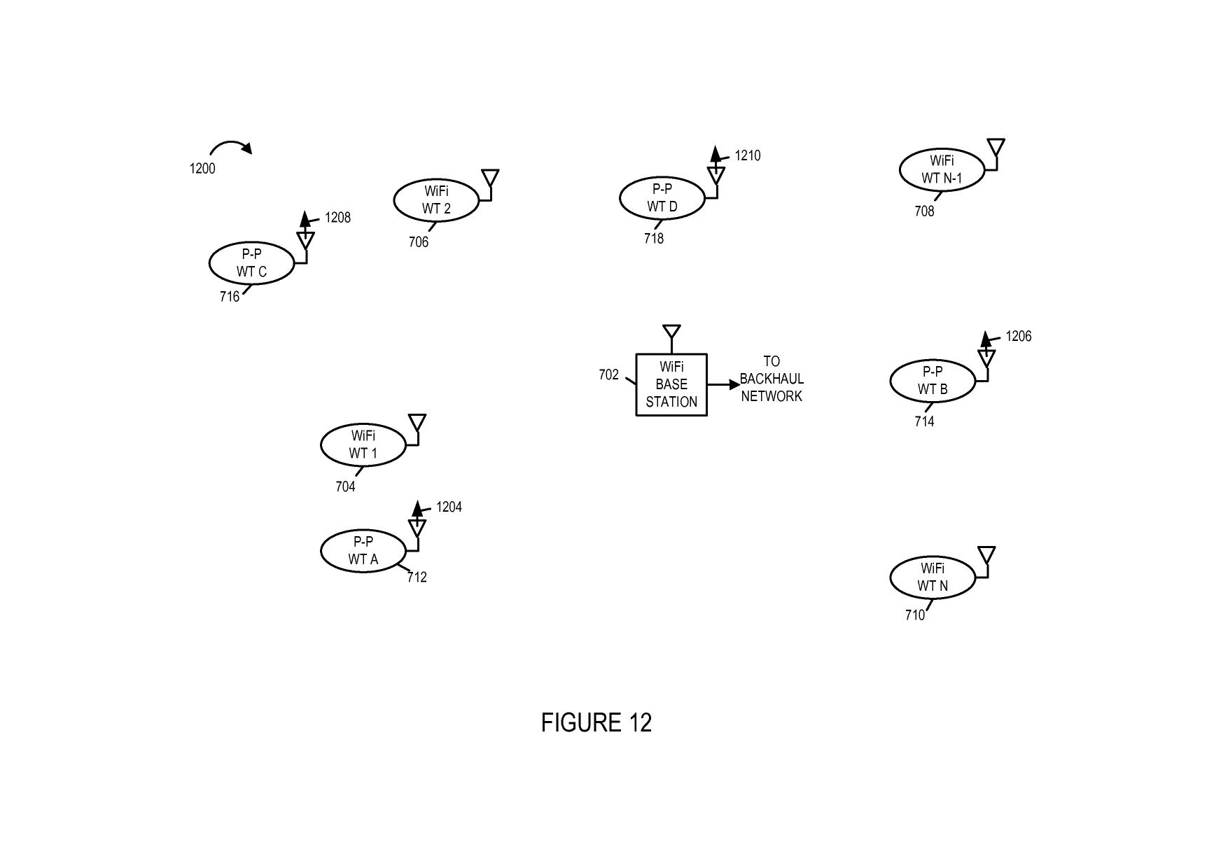

In the example, of FIG. 12 in drawing 1200, peer to peer WT A 712 transmits S-CTS signal 1204, in response to the decision of block 1130 of FIG. 11; peer to peer WT B 714 transmits S-CTS signal 1206; peer to peer WT C 716 transmits S-CTS signal 1208; and peer to peer WT D 718 transmits S-CTS signal 1210.

The generation of a SSUM and a decision as to whether or not to transmit a transmission suppression signal have been described in terms of operations performed by peer to peer wireless terminal A 712. It should be appreciated that the other peer to peer wireless terminals, e.g., devices 714, 716, and 718 are also performing similar operations. In addition it should be appreciated that transmission suppression signals transmitted by the peer to peer to peer devices are being used to suppress transmission in the WiFi network, e.g., WiFi devices which receive the S-CTS signals are prevented from transmitting for a period of time in response to the received S-CTS signal in accordance with the WiFi protocol for a received CTS signal.

In some embodiments, in addition to deciding whether or not to transmit a transmission suppression signal based on a generated SSUM, a peer to peer wireless communications device decides a rate at which to transmit a transmission suppression signal as a function of the generated SSUM.

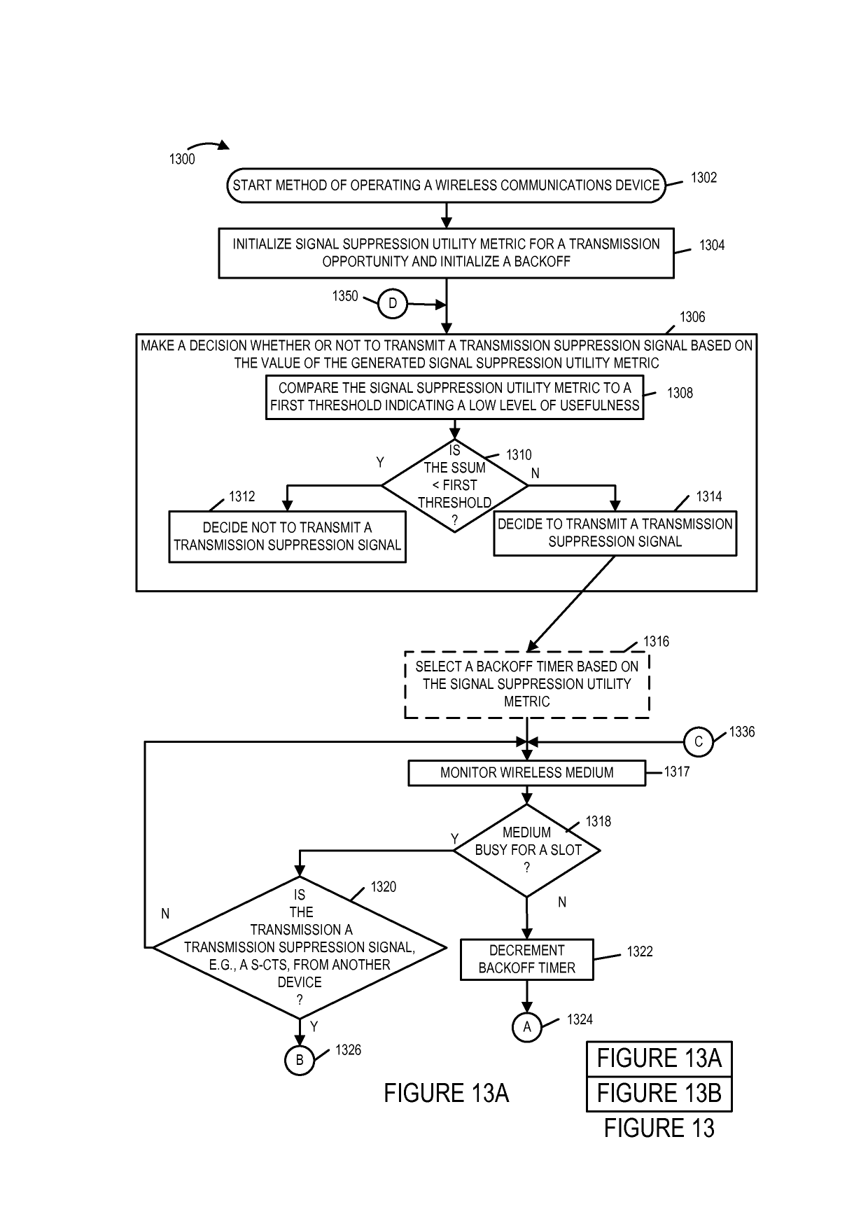

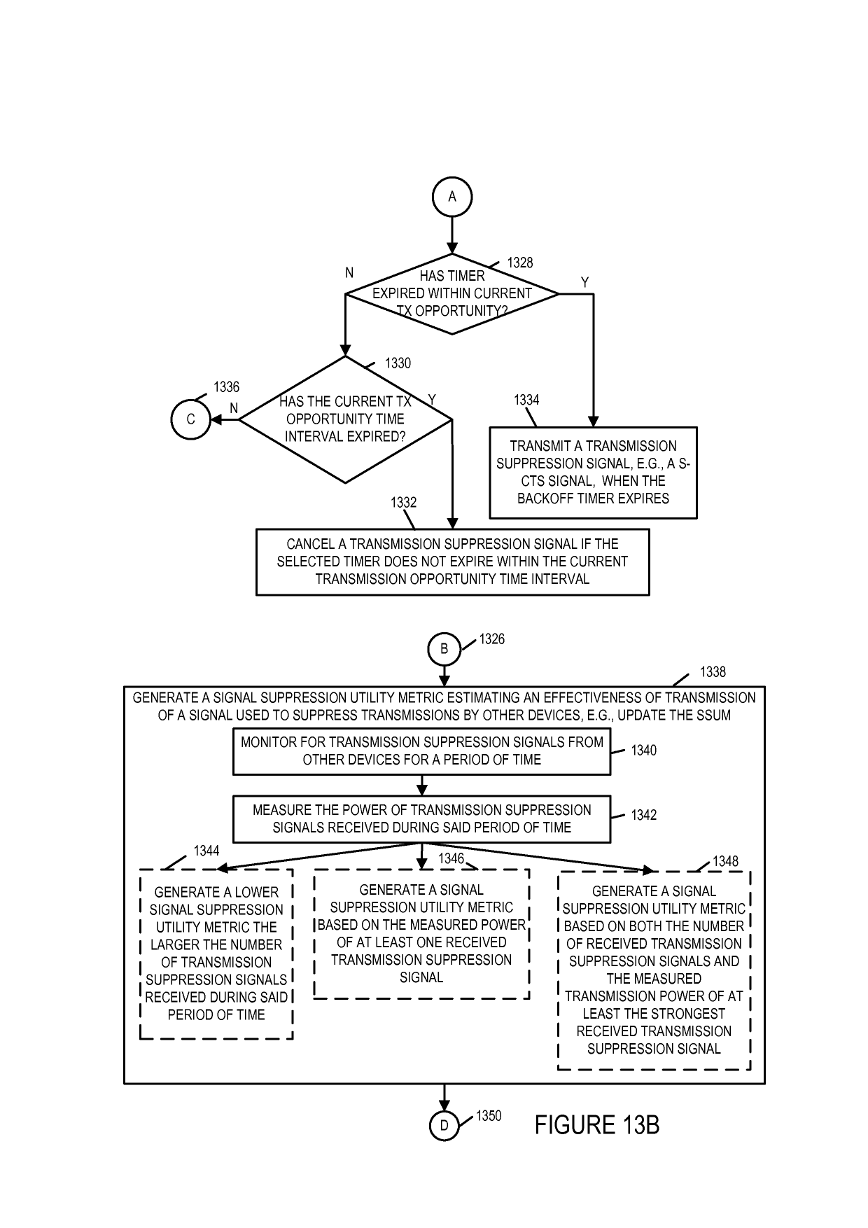

FIG. 13, comprising the combination of FIG. 13A and FIG. 13B, is a flowchart 1300 of an exemplary method of operating a wireless communications device in accordance with an exemplary embodiment. The wireless communications device implementing the method of flowchart 1300 is, e.g., one of the peer to peer wireless terminals (112, . . . , 114) of system 100 of FIG. 1. In the flowchart 1300 of FIG. 13, a wireless communications device updates a signal suppression utility metric (SSUM) and determines whether or not to transmit a transmission suppression signal, e.g., a S-CTS signal, based on the SSUM.

Operation starts in step 1302, where the wireless communications device is powered on and initialized. Operation proceeds from start step 1302 to step 1304. In step 1304 the wireless communications device initializes a signal suppression utility metric (SSUM) for a transmission opportunity and initializes a backoff. Operation proceeds from step 1304 to step 1306.

In step 1306 the wireless communications device makes a decision whether or not to transmit a transmission suppression signal, e.g., a S-CTS signal, based on the value of the generated signal suppression utility metric. In some embodiments, the transmission suppression signal is a S-CTS signal and the wireless communications device is a peer to peer communications device that uses a communications protocol which is not compliant with WiFi, and the WiFi is to be suppressed by transmission of the S-CTS signal. Step 1306 includes steps 1308, 1310, 1312 and 1314. In step 1308 the wireless communications device compares the signal suppression utility metric to a first threshold. Operation proceeds from step 1308 to step 1310. In step 1310, if the signal suppression utility metric is less than the first threshold indicating a low level of usefulness, operation proceeds from step 1310 to step 1312, where the wireless communications device decides not to transmit a transmission suppression signal. However, if the signal suppression utility metric is greater than or equal to the first threshold, then operation proceeds from step 1310 to step 1314, in which the wireless communications device decides to transmit a transmission suppression signal.

In some embodiments, operation proceeds from step 1314 to step 1316. In other embodiments, operation proceeds from step 1314 to step 1317. Returning to step 1316 in step 1316 the wireless communications device selects a backoff timer based on the signal suppression utility metric. Operation proceeds from step 1316 to step 1317.

In step 1317 the wireless communications device monitors wireless medium. Operation proceeds from step 1317 to step 1318. In step 1318 the wireless communications device determines if the medium is busy for a slot. If the wireless communications device determines that the medium is busy for a slot, then operation proceeds from step 1318 to step 1320. However, if the wireless communications device determines that the medium is not busy for the slot, then operation proceeds to step 1322, where the wireless communications device decrements the backoff timer. Operation proceeds from step 1322 via connecting node A 1324 to step 1328.

In step 1328 the wireless communications device determines if the backoff timer has expired within the current transmission opportunity time interval. If the backoff timer has expired then operation proceeds from step 1328 to step 1334 in which the wireless communications device transmits a transmission suppression signal, e.g., a S-CTS signal, when the backoff timer expires. However, if the backoff timer has not expired, then operation proceeds from step 1328 to step 1339, where the wireless communications device checks if the current transmission opportunity time interval has expired. If the current transmission opportunity time interval has expired, then operation proceeds from step 1330 to step 1332 where the wireless communications device cancels a transmission suppression signal since the selected backoff time did not expire within the current transmission opportunity time interval and the current transmission opportunity time interval has ended.

However, if the check of step 1330 determined that the current transmission opportunity time interval has not expired then operation proceeds from step 1330, via connecting node C 1336 to step 1317.

Returning to step 1320, in step 1320 the wireless communications device determines if the detected transmission causing the medium to be busy for a slot is a transmission suppression signal, e.g., a S-CTS signal, from another device. If the transmission is not a transmission suppression signal, then operation proceeds from step 1320 to step 1317 for additional monitoring of the medium. However, if the detected transmission is a transmission suppression signal, then operation proceeds from step 1320 to step 1338, via connecting node B 1326.

In step 1338 the wireless communications device generates a signal suppression utility metric (SSUM) estimating an effectiveness of transmission of a signal used to suppress transmission by other devices, e.g., the wireless communications device updates the SSUM. Step 1338 includes step 1340 and 1342. In some embodiments, step 1308 includes one or more or all of steps 1344, 1346 and 1348. In step 1340 the wireless communications device monitors for transmission suppression signals, e.g., S-CTS signals, from other devices for a period of time. Then, in step 1342 the wireless communications device measures the power of transmission suppression signals received during said period of time. In step 1344 the wireless communications device generates a lower signal suppression utility metric the larger the number of transmission suppression signals received during said time period. In step 1346 the wireless communications device generates a signal suppression utility metric based on the measured power of at least one received transmission suppression signal. In some embodiments, in step 1344 the wireless communications device generates a signal suppression utility metric (S SUM) based on a signal suppression utility metric (S SUM) function which uses the measured power of at least one received transmission suppression signal as an input and which produces a lower signal suppression utility metric (SSUM) value for a high received power level than for a low received power level. In step 1348 the wireless communications device generates a signal suppression utility metric based on both the number of received transmission suppression signals and the measured transmission power of at least the strongest received transmission suppression signal. Operation proceeds from step 1338 via connecting node D 1350 to the input of step 1306.

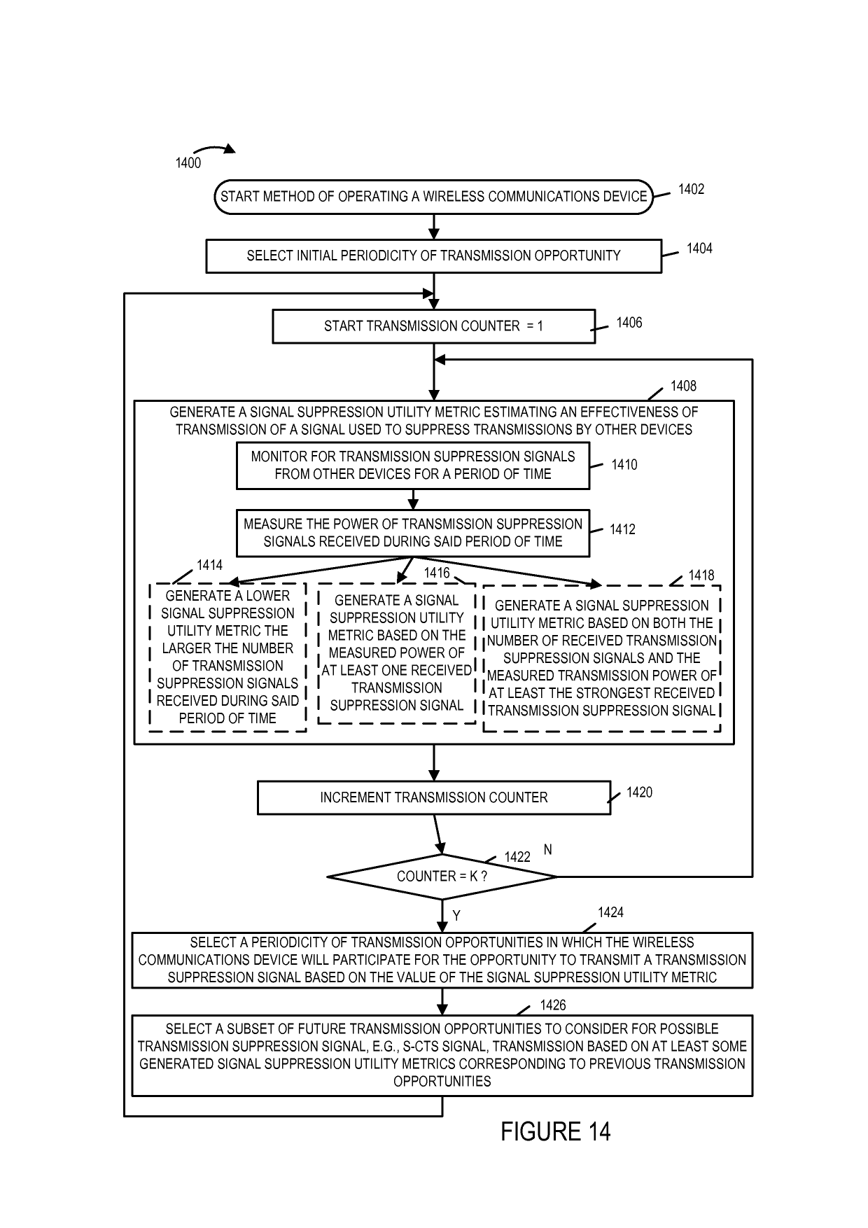

FIG. 14 is a flowchart 1400 of an exemplary method of operating a wireless communications device in accordance with an exemplary embodiment. The wireless communications device implementing the method of flowchart 1400 is, e.g., one of the peer to peer wireless terminals (112, . . . , 114) of system 100 of FIG. 1. In the flowchart 1400 of FIG. 14, a wireless communications device selects periodicity of transmission opportunity on a slower time scale than transmission suppression opportunities, e.g., the wireless communications device selects periodicity and future transmission opportunities after K S-CTS transmission opportunities.

Operation starts in step 1402, where the wireless communications device is powered on and initialized. Operation proceeds from start step 1402 to step 1404. In step 1404 the wireless communications device selects initial periodicity of transmission opportunity. Operation proceeds from step 1404 to step 1406. In step 1406 the wireless communications device starts a transmission counter at 1, e.g., set a transmission counter=1. Operation proceeds from step 1406 to step 1408.

In step 1408 the wireless communications device generates a signal suppression utility metric (SSUM) estimating an effectiveness of transmission of a signal used to suppress transmission by other devices. Step 1408 includes step 1410 and 1412. In some embodiments, step 1418 includes one or more or all of steps 1414, 1416 and 1418. In step 1410 the wireless communications device monitors for transmission suppression signals, e.g., S-CTS signals, from other devices for a period of time. Then, in step 1412 the wireless communications device measures the power of transmission suppression signals received during said period of time. In step 1414 the wireless communications device generates a lower signal suppression utility metric the larger the number of transmission suppression signals received during said time period. In step 1416 the wireless communications device generates a signal suppression utility metric based on the measured power of at least one received transmission suppression signal. In some embodiments, in step 1416 the wireless communications device generates a signal suppression utility metric (SSUM) based on a signal suppression utility metric (SSUM) function which uses the measured power of at least one received transmission suppression signal as an input and which produces a lower signal suppression utility metric (SSUM) value for a high received power level than for a low received power level. In step 1418 the wireless communications device generates a signal suppression utility metric based on both the number of received transmission suppression signals and the measured transmission power of at least the strongest received transmission suppression signal.

Operation proceeds from step 1408 to step 1420. In step 1420 the wireless communications device increments the transmission counter. Then in step 1422 the wireless communications device tests whether or not the transmission counter equals K, where K is a positive integer greater than or equal to 2. In some embodiments, K is a predetermined fixed value. In some embodiments, K is greater than or equal to 10. In some embodiments, K is greater than or equal to 50. In some embodiments, K can, and sometimes does, depend on the current periodicity of the signal suppression signal transmission chosen by the device.

If the test of step 1422 indicates that the transmission counter is not equal to K, then operation proceeds from step 1422 to step 1408. However, if the test of step 1422 indicates that the counter is equal to K, then operation proceeds from step 1422 to step 1424.

In step 1424 the wireless communications device selects a periodicity of transmission opportunities in which the wireless communications device will participate for the opportunity to transmit a transmission suppression signal based on the value of the signal suppression utility metric. In some embodiments, the lower the SSUM the less frequent the transmission opportunities in which the device participates. Operation proceeds from step 1424 to step 1426. In step 1426 the wireless communications device selects a subset of future transmission opportunities to consider for possible transmission suppression signal, e.g., S-CTS signal, transmission based on at least some generated signal suppression utility metrics corresponding to the previous transmission opportunities. For example, the wireless communications device selects a particular subset of recurring transmission opportunities, e.g., the wireless communications device selects the first one of each three transmission opportunities to consider for transmitting in. Operation proceeds from step 1426 to step 1406.

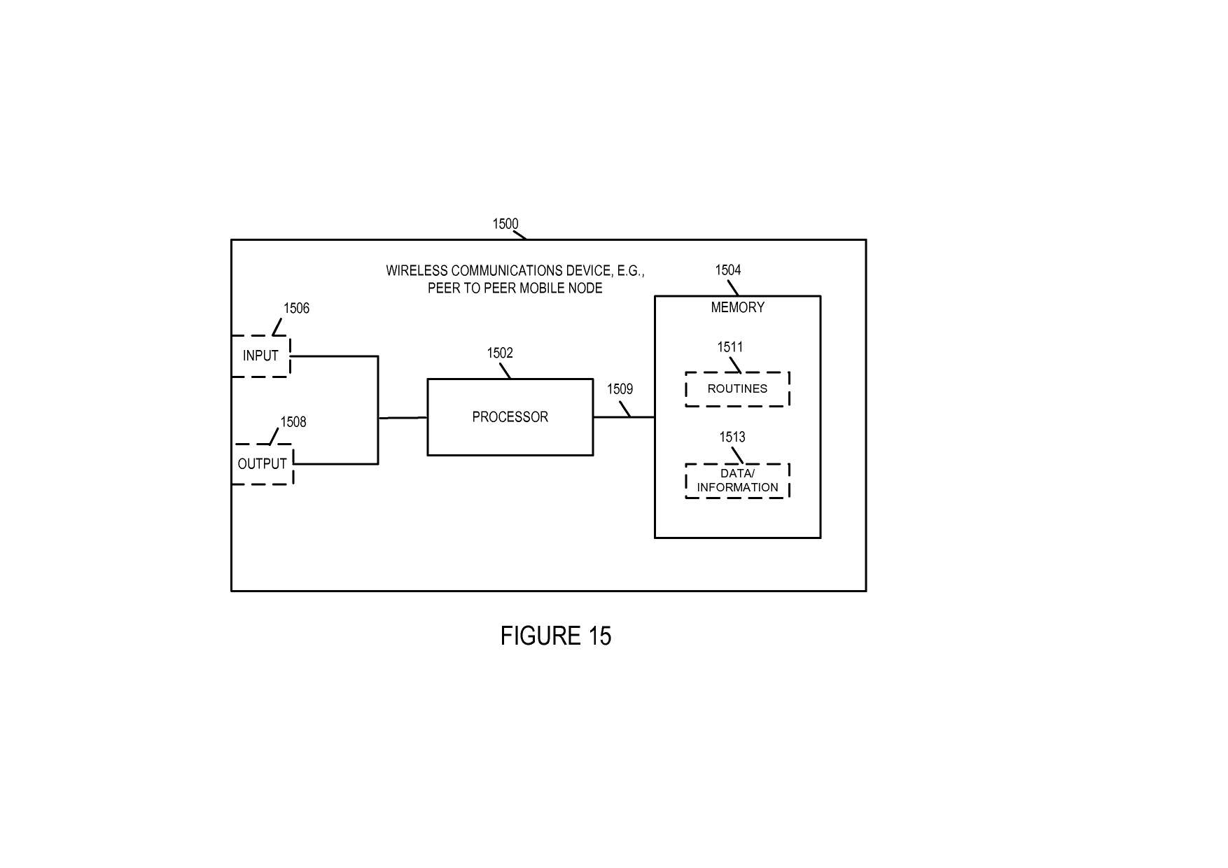

FIG. 15 is a drawing of an exemplary wireless communications device 1500, e.g., a peer to peer mobile node, in accordance with an exemplary embodiment. Exemplary communications device 1500 is, e.g., one of the peer to peer wireless communications devices (112, . . . , 114) of system 100 of FIG. 1. Exemplary wireless communications device 1500 may, and sometimes does, implement a method in accordance with flowchart 1300 of FIG. 13.

Wireless communications device 1500 includes a processor 1502 and memory 1504 coupled together via a bus 1509 over which the various elements (1502, 1504) may interchange data and information. Communications device 1500 further includes an input module 1506 and an output module 1508 which may be coupled to processor 1502 as shown. However, in some embodiments, the input module 1506 and output module 1508 are located internal to the processor 1502. Input module 1506 can receive input signals. Input module 1506 can, and in some embodiments does, include a wireless receiver and/or a wired or optical input interface for receiving input. Output module 1508 may include, and in some embodiments does include, a wireless transmitter and/or a wired or optical output interface for transmitting output. In some embodiments, memory 1504 includes routines 1511 and data/information 1513.

In some embodiments, processor 1502 is configured to implement each of the steps of the exemplary method of flowchart 1300 of FIG. 13.

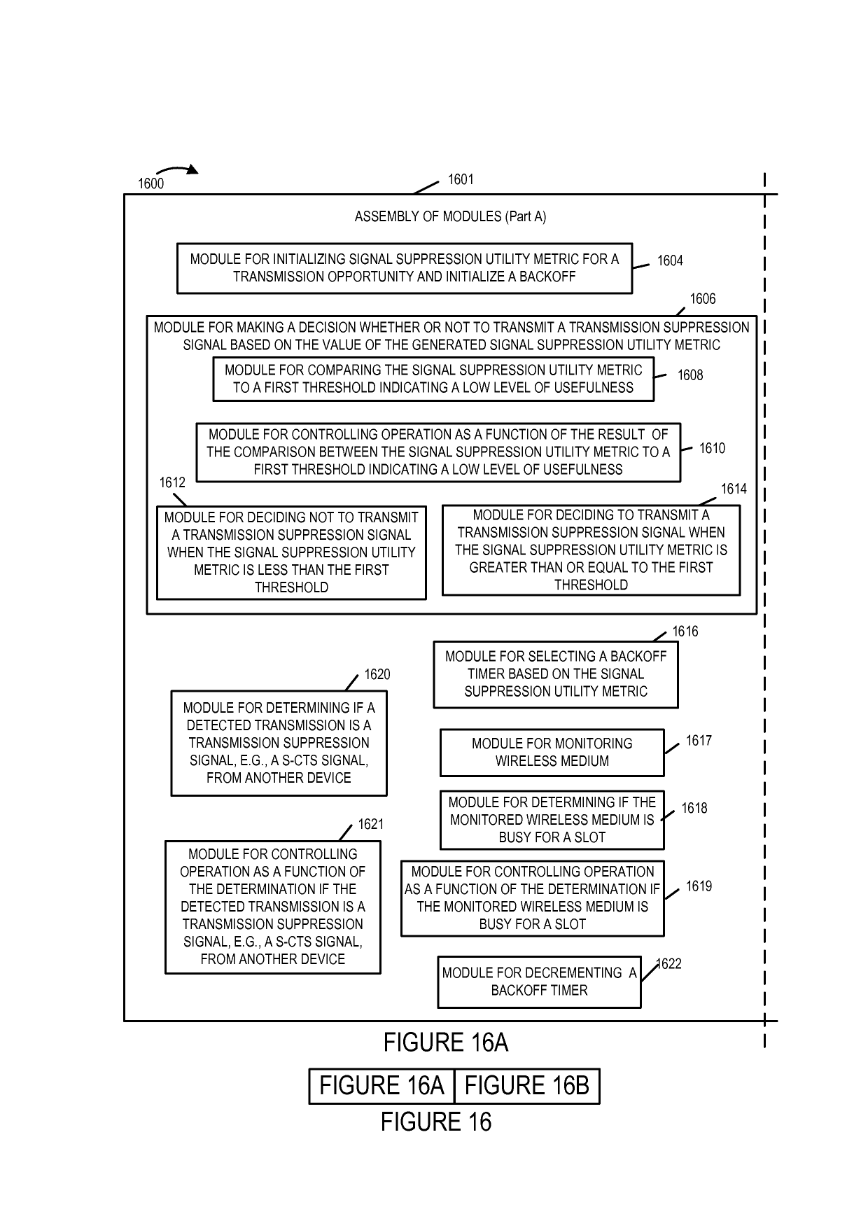

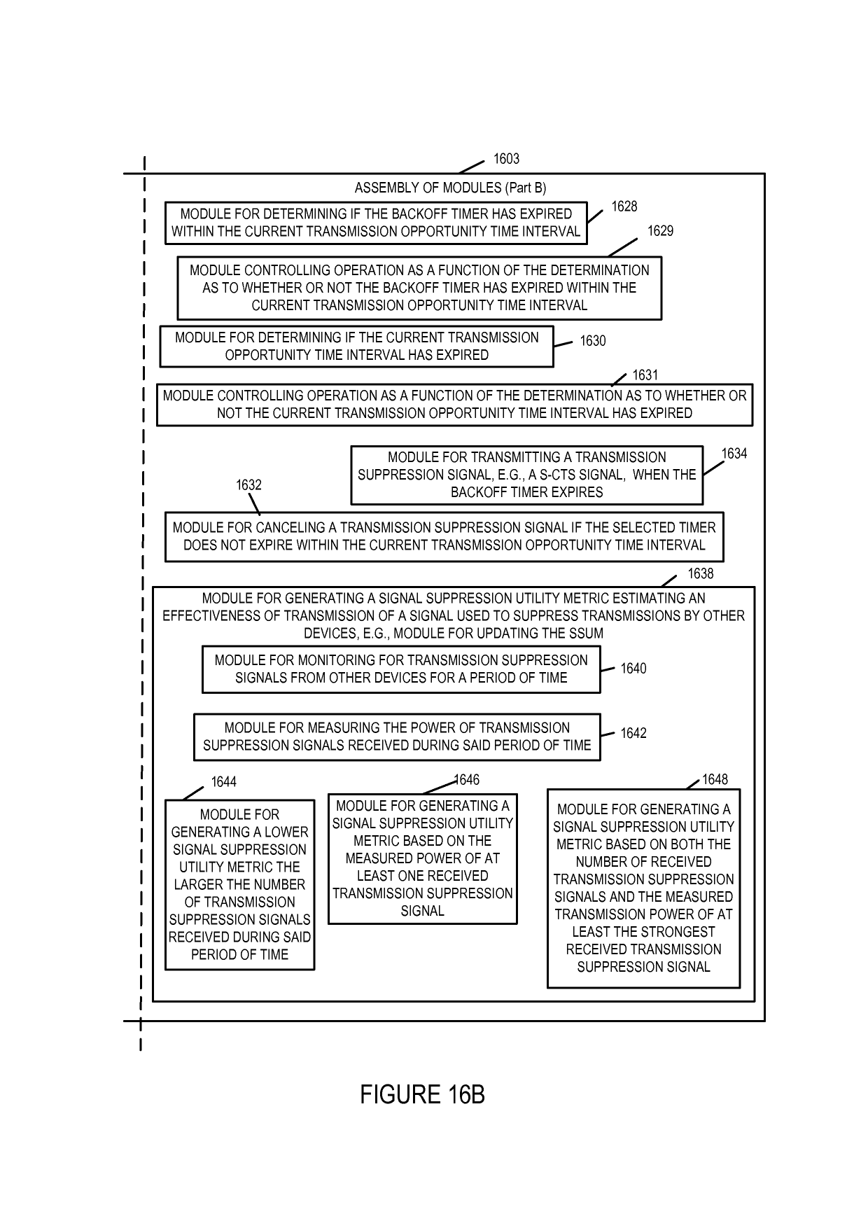

FIG. 16, comprising the combination of FIG. 16 and FIG. 16B is an assembly of modules 1600 which can, and in some embodiments is, used in the exemplary wireless communications device 1500 illustrated in FIG. 15. The modules in the assembly 1600 can be implemented in hardware within the processor 1502 of FIG. 15, e.g., as individual circuits. Alternatively, the modules may be implemented in software and stored in the memory 1504 of wireless communications device 1500 shown in FIG. 15. In some such embodiments, the assembly of modules 1600 is included in routines 1511 of memory 1504 of device 1500 of FIG. 15. While shown in the FIG. 15 embodiment as a single processor, e.g., computer, it should be appreciated that the processor 1502 may be implemented as one or more processors, e.g., computers. When implemented in software the modules include code, which when executed by the processor, configure the processor, e.g., computer, 1502 to implement the function corresponding to the module. In some embodiments, processor 1502 is configured to implement each of the modules of the assembly of modules 1600. In embodiments where the assembly of modules 1600 is stored in the memory 1504, the memory 1504 is a computer program product comprising a computer readable medium, e.g., a non-transitory computer readable medium, comprising code, e.g., individual code for each module, for causing at least one computer, e.g., processor 1502, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 16 control and/or configure the wireless communications device 1500 or elements therein such as the processor 1502, to perform the functions of the corresponding steps illustrated and/or described in the method of flowchart 1300 of FIG. 13.

Assembly of modules 1600 includes part A 1601 and part B 1603. Assembly of modules 1600 includes a module for initializing a signal suppression utility metric (SSUM) for a transmission opportunity and initializing a backoff timer 1604. Assembly of modules 1600 further includes a module for making a decision whether or not to transmit a transmission suppression signal based on the value of the generated signal suppression utility metric 1606. Module 1606 includes a module for comparing the signal suppression utility metric to a first threshold indicating a low level of usefulness 1608, a module for controlling operation as a function of the result of the comparison between the signal suppression utility metric to a first threshold indicating a low level of usefulness 1610, a module for deciding not to transmit a transmission suppression signal when the signal suppression utility metric is less than a first threshold indicating a low level of usefulness 1612 and a module for deciding to transmit a signal suppression utility metric when the signal suppression utility metric is greater than or equal to a first threshold 1614.

Assembly of modules 1600 further includes a module for selecting a backoff timer based on the signal suppression utility metric 1616, a module for monitoring wireless medium 1617, a module for determining if the monitored wireless medium is busy for a slot 1618, a module for controlling operation as a function of the determination if the monitored wireless medium is busy for a slot 1619, a module for determining if a detected transmission is a transmission suppression signal, e.g., a S-CTS signal, from another device 1620, a module for controlling operation as a function of the determination if the detected transmission is a transmission suppression signal, e.g., a S-CTS signal, from another device, and a module for decrementing a backoff timer 1622.

Assembly of modules 1600 further includes a module for determining if the backoff time has expired within the current transmission opportunity time interval 1628, a module for controlling operation as a function of the determination as to whether or not the backoff time has expired within the current transmission opportunity time interval 1629, a module for determining if the current transmission time interval has expired 1630, a module for controlling operation as a function of the determination as to whether or not the current transmission opportunity time interval has expired 1631, a module for canceling a transmission suppression signal if the selected timer does not expire within the current transmission opportunity time interval 1632, and a module for transmitting a transmission suppression signal, e.g., a S-CTS signal, when the backoff timer expires 1634.

Assembly of modules 1600 further includes a module for generating a signal suppression utility metric estimating an effectiveness of transmission of a signal used to suppress transmissions by other devices 1638, e.g., a module for updating the SSUM. Module 1638 for generating as signal suppression utility metric includes a module for monitoring for transmission suppression signals from other devices for a period of time 1640, a module for measuring the power of transmission suppression signals received during said period of time 1642, a module for generating a lower signal suppression utility metric the larger the number of transmission suppression signals received during said time period 1644, a module for generating a signal suppression utility metric based on the measured power of at least one received transmission suppression signal based 1646, and a module for generating a signal suppression utility metric based on both the number of received transmission suppression signals and the measured transmission power of at least the strongest received transmission suppression signal 1648. In some embodiments, module 1646 generates a signal suppression utility metric (SSUM) based on a signal suppression utility metric (SSUM) function which uses the measured power of at least one received transmission suppression signal as an input and which produces a lower signal suppression utility metric (SSUM) value for a high received power level than for a low received power level.

In some embodiments, the transmission suppression signal is a S-CTS signal and the wireless communications device including assembly of modules 1600 is a peer to peer communications device that uses a communications protocol that is not compliant with WiFi, which is to be suppressed by transmission of the S-CTS signal. In some embodiments the S-CTS signal is a CTS to self signal.

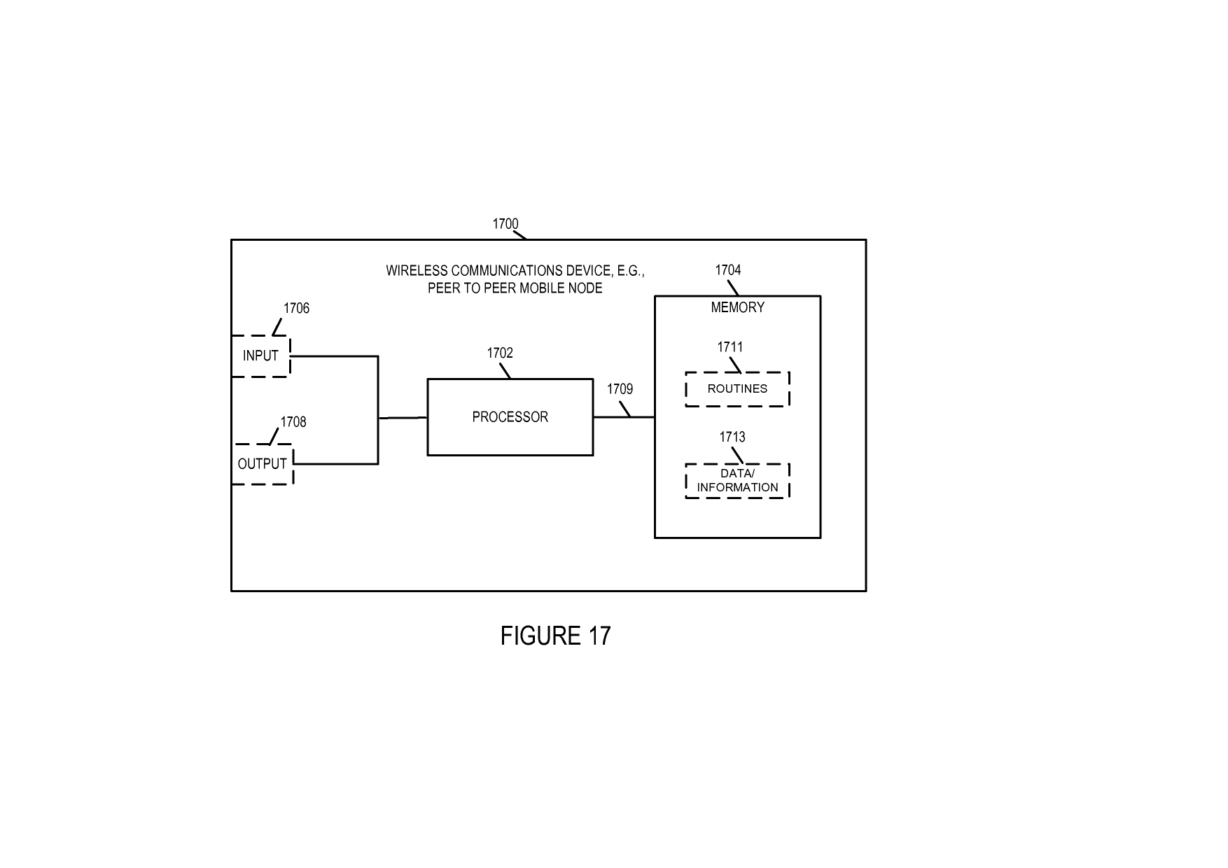

FIG. 17 is a drawing of an exemplary wireless communications device 1700, e.g., a peer to peer mobile node, in accordance with an exemplary embodiment. Exemplary communications device 1700 is, e.g., one of the peer to peer wireless communications devices (112, . . . , 114) of system 100 of FIG. 1. Exemplary wireless communications device 1700 may, and sometimes does, implement a method in accordance with flowchart 1400 of FIG. 14.

Wireless communications device 1700 includes a processor 1702 and memory 1704 coupled together via a bus 1709 over which the various elements (1702, 1704) may interchange data and information. Communications device 1700 further includes an input module 1706 and an output module 1708 which may be coupled to processor 1702 as shown. However, in some embodiments, the input module 1706 and output module 1708 are located internal to the processor 1702. Input module 1706 can receive input signals. Input module 1706 can, and in some embodiments does, include a wireless receiver and/or a wired or optical input interface for receiving input. Output module 1708 may include, and in some embodiments does include, a wireless transmitter and/or a wired or optical output interface for transmitting output. In some embodiments, memory 1704 includes routines 1711 and data/information 1713.

In some embodiments, processor 1702 is configured to implement each of the steps of the exemplary method of flowchart 1400 of FIG. 14.

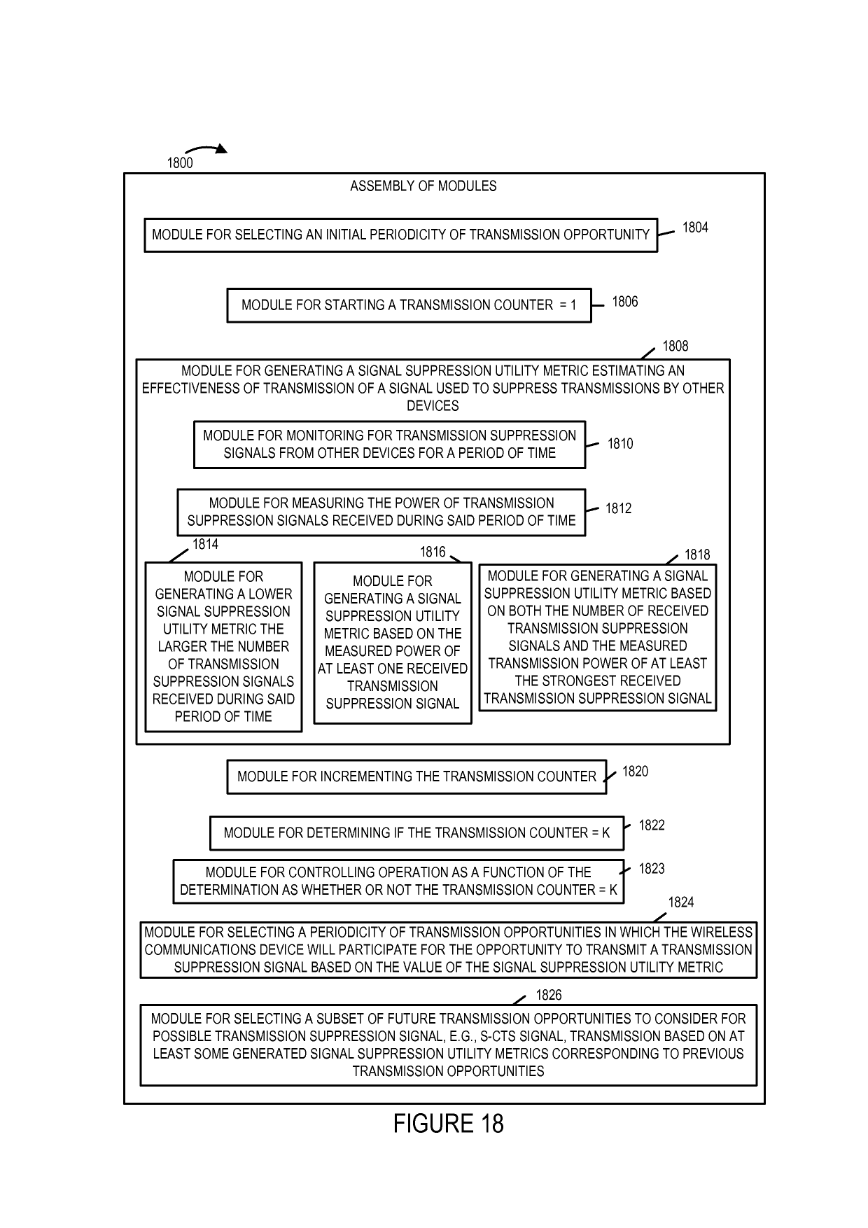

FIG. 18 is an assembly of modules 1800 which can, and in some embodiments is, used in the exemplary wireless communications device 1700 illustrated in FIG. 17. The modules in the assembly 1800 can be implemented in hardware within the processor 1702 of FIG. 17, e.g., as individual circuits. Alternatively, the modules may be implemented in software and stored in the memory 1704 of wireless communications device 1700 shown in FIG. 17. In some such embodiments, the assembly of modules 1800 is included in routines 1711 of memory 1704 of device 1700 of FIG. 17. While shown in the FIG. 17 embodiment as a single processor, e.g., computer, it should be appreciated that the processor 1702 may be implemented as one or more processors, e.g., computers. When implemented in software the modules include code, which when executed by the processor, configure the processor, e.g., computer, 1702 to implement the function corresponding to the module. In some embodiments, processor 1702 is configured to implement each of the modules of the assembly of modules 1800. In embodiments where the assembly of modules 1800 is stored in the memory 1704, the memory 1704 is a computer program product comprising a computer readable medium, e.g., a non-transitory computer readable medium, comprising code, e.g., individual code for each module, for causing at least one computer, e.g., processor 1702, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 18 control and/or configure the wireless communications device 1700 or elements therein such as the processor 1702, to perform the functions of the corresponding steps illustrated and/or described in the method of flowchart 1400 of FIG. 14.

Assembly of modules 1800 includes a module for selecting an initial periodicity of transmission opportunities 1804, a module for starting a transmission counter at a value of 1 1806, e.g., a module for initializing a transmission counter to 1, and a module for generating a signal suppression utility metric estimating an effectiveness of transmission of a signal used to suppress transmissions by other devices 1808. Module 1808 for generating as signal suppression utility metric includes a module for monitoring for transmission suppression signals from other devices for a period of time 1810, a module for measuring the power of transmission suppression signals received during said period of time 1812, a module for generating a lower signal suppression utility metric the larger the number of transmission suppression signals received during said time period 1814, a module for generating a signal suppression utility metric based on the measured power of at least one received transmission suppression signal based 1816, and a module for generating a signal suppression utility metric based on both the number of received transmission suppression signals and the measured transmission power of at least the strongest received transmission suppression signal 1818. In some embodiments, module 1816 generates a signal suppression utility metric (SSUM) based on a signal suppression utility metric (SSUM) function which uses the measured power of at least one received transmission suppression signal as an input and which produces a lower signal suppression utility metric (SSUM) value for a high received power level than for a low received power level.

Assembly of modules 1800 further includes a module for incrementing the transmission counter 1820, a module for determining if the transmission counter =K 1822, a module for controlling operation as a function of the determination whether or not the transmission counter=L 1823. Assembly of modules 1800 further includes a module for selecting a periodicity of transmission opportunities on which the wireless communications device will participate for the opportunity to transmit a transmission suppression signal based on the value of the signal suppression utility metric 1824 and a module for selecting a subset of future transmission opportunities to consider for possible transmission suppression signal, e.g., S-CTS signal, transmission based on at least some generated signal suppression utility metrics corresponding to previous transmission opportunities 1826. In some embodiments, module 418 selects periodicity such that the lower the SSUM the less frequent the transmission opportunities in which the wireless communications device will participate.

In some embodiments, the transmission suppression signal is a S-CTS signal and the wireless communications device including assembly of modules 1800 is a peer to peer communications device that uses a communications protocol that is not compliant with WiFi, which is to be suppressed by transmission of the S-CTS signal. In some embodiments the S-CTS signal is a CTS to self signal.

In various embodiments a device, e.g., a peer to peer wireless communications device in system 100 of FIG. 1, and/or wireless communication device 300 of FIG. 3, and/or one of the devices of FIG. 5 and/or one of the peer to peer wireless terminals of FIGS. 7-12 and/or wireless communications device 1500 of FIG. 15 and/or wireless communications device 1700 of FIG. 17 includes a module corresponding to each of the individual steps and/or operations described with regard to any of the figures in the present application and/or described in the detailed description of the present application. In some embodiments, the modules are implemented in hardware, e.g., in the form of circuits. Thus, in at least some embodiments the modules may, and sometimes are implemented in hardware. In other embodiments, the modules may, and sometimes are, implemented as software modules including processor executable instructions which when executed by the processor of the communications device cause the device to implement the corresponding step or operation. In still other embodiments, some or all of the modules are implemented as a combination of hardware and software.

The techniques of various embodiments may be implemented using software, hardware and/or a combination of software and hardware. Various embodiments are directed to apparatus, e.g., network nodes, mobile nodes such as mobile terminals supporting peer to peer communications, access points such as base stations, and/or communications systems. Various embodiments are also directed to methods, e.g., method of controlling and/or operating network nodes, mobile nodes, access points such as base stations and/or communications systems, e.g., hosts. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal processing, signal generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., communications node, including a processor configured to implement one, multiple or all of the steps of one or more methods of the invention.

In some embodiments, the processor or processors, e.g., CPUs, of one or more devices, e.g., communications nodes such as network nodes, access nodes and/or wireless terminals, are configured to perform the steps of the methods described as being performed by the communications nodes. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., communications node, with a processor which includes a module corresponding to each of the steps of the various described methods performed by the device in which the processor is included. In some but not all embodiments a device, e.g., a communications node, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

Various embodiments are well suited to communications systems using a peer to peer signaling protocol. Some embodiments use an Orthogonal Frequency Division Multiplexing (OFDM) based wireless peer to peer signaling protocol, e.g., WiFi signaling protocol or another OFDM based protocol.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with Code Division Multiple Access (CDMA), OFDM, and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

What is claimed is:

1. A method of operating a wireless communications device comprising:
generating a signal suppression utility metric (SSUM) estimating an effectiveness of transmission of a signal used to suppress transmissions by other devices; and
making a decision whether or not to transmit a transmission suppression signal based on the value of the generated SSUM.

2. The method of claim 1,
wherein said transmission suppression signal is a S-CTS signal and
wherein said wireless communications device is a peer-to-peer communications device that uses a communications protocol which is not compliant with WiFi which is to be suppressed by transmission of said S-CTS signal.

3. The method of claim 1, wherein generating the SSUM includes:
monitoring for transmission suppression signals from other devices for a period of time; and
measuring the power of transmission suppression signals received during said period of time.

4. The method of claim 3, wherein generating the SSUM further includes:
generating a lower SSUM the larger the number of transmission suppression signals received during said period of time.

5. The method of claim 3, wherein generating the SSUM further includes:
generating a SSUM based on the measured power of at least one received transmission suppression signal.

6. The method of claim 3, wherein the generation of said SSUM is based on both the number of received transmission suppression signals and the measured transmission power of at least the strongest received transmission suppression signal.

7. The method of claim 6, further comprising:
deciding not to transmit a transmission suppression signal when the SSUM is below a first threshold indicating a low level of usefulness.

8. The method of claim 7, further comprising:
deciding to transmit the transmission suppression signal when the SSUM equals or exceeds said first threshold.

9. The method of claim 8, further comprising:
selecting a backoff timer based on said SSUM, said backoff timer being used in determining when to transmit said transmission suppression signal during a transmission opportunity time interval, the selected backoff time being larger for small SSUM indicating low usefulness than for higher SSUMs; and
canceling a transmission suppression signal if the selected backoff timer does not expire within the current transmission opportunity time interval.

10. A wireless communications device comprising:
means for generating a signal suppression utility metric (SSUM) estimating an effectiveness of transmission of a signal used to suppress transmissions by other devices; and
means for making a decision whether or not to transmit a transmission suppression signal based on the value of the generated SSUM.

11. The wireless communications device of claim 10,
wherein said transmission suppression signal is a S-CTS signal and
wherein said wireless communications device is a peer-to-peer communications device that uses a communications protocol which is not compliant with WiFi which is to be suppressed by transmission of said S-CTS signal.

12. The wireless communications device of claim 10, wherein said means for generating the SSUM includes:
means for monitoring for transmission suppression signals from other devices for a period of time; and
means for measuring the power of transmission suppression signals received during said period of time.

13. The wireless communications device of claim 12, wherein said means for generating the SSUM further includes:
means for generating a lower SSUM the larger the number of transmission suppression signals received during said period of time.

14. The wireless communications device of claim 12, wherein said means for generating the SSUM further includes:
means for generating a SSUM based on the measured power of at least one received transmission suppression signal.

15. A computer program product for use in a wireless communications device, the computer program product comprising:
a non-transitory computer readable medium comprising:
code for causing at least one computer to generate a signal suppression utility metric (SSUM) estimating an effectiveness of transmission of a signal used to suppress transmissions by other devices; and
code for causing said at least one computer to make a decision whether or not to transmit a transmission suppression signal based on the value of the generated SSUM.

16. A wireless communications device comprising:
at least one processor configured to:
generate a signal suppression utility metric (SSUM) estimating an effectiveness of transmission of a signal used to suppress transmissions by other devices; and
make a decision whether or not to transmit a transmission suppression signal based on the value of the generated SSUM; and
memory coupled to said at least one processor.

17. The wireless communications device of claim 16,
wherein said transmission suppression signal is a S-CTS signal;
wherein said wireless communications device is a peer-to-peer communications device; and
wherein said at least one processor is further configured to use a communications protocol which is not compliant with WiFi which is to be suppressed by transmission of said S-CTS signal.

18. The wireless communications device of claim 16, wherein said at least one processor is configured to:
monitor for transmission suppression signals from other devices for a period of time; and
measure the power of transmission suppression signals received during said period of time,
as part of being configured to generating the SSUM.

19. The wireless communications device of claim 18, wherein said at least one processor is configured to:
generate a lower SSUM the larger the number of transmission suppression signals received during said period of time,
as part of being configured to generating the SSUM.

20. The wireless communications device of claim 18, wherein said at least one processor is configured to:
generate a SSUM based on the measured power of at least one received transmission suppression signal.
